(19) United States
(12) Patent Application Publication
(10) Pub. No.: US 2026/0269318 A1
(43) Pub. Date: Sep. 10, 2026

(54) ELECTROLYTE COMPRISING CYCLIC QUATERNARY AMMONIUM IONIC LIQUID AND SOLVENT WITH HIGH BOILING POINT AND BATTERIES COMPRISING SAME

(71) Applicant: Factorial Inc., Billerica, MA (US)

(72) Inventors: Zhangxing Shi, Winchester, MA (US); Yiqing Huang, Lexington, MA (US); Jia Du, Burlington, MA (US); Dong Ren, Woburn, MA (US)

(73) Assignee: Factorial Inc., Billerica, MA (US)

(21) Appl. No.: 19/473,283

(22) PCT Filed: Aug. 22, 2024
(86) PCT No.: PCT/US2024/043346

§ 371 Date: Oct. 7, 2025

Related U.S. Application Data
(60) Provisional application No. 63/535,672, filed on Aug. 31, 2023.

(51) Int. Cl. H01M 10/0567; H01M 10/0525; H01M 10/0569

(52) U.S. Cl. CPC H01M 10/0567; H01M 10/0525; H01M 10/0569; H01M 2300/0034

(57) ABSTRACT

Disclosed is an electrolyte comprising a cyclic quaternary ammonium ionic liquid, a lithium salt, and an organic solvent with a high boiling point. In one embodiment, the organic solvent has a boiling point of at least 100° C. In one embodiment, the cyclic quaternary ammonium ionic liquid and the lithium salt share the same anion. An electrochemical device comprising the same and preparation method therefor are also disclosed.

### CROSS-REFERENCE

The present application claims priority of U.S. Ser. No. 63/535,672, filed Aug. 31, 2023, the entire content of which is incorporated herein by reference into this application.

### FIELD

Disclosed are an electrolyte comprising a cyclic quaternary ammonium ionic liquid, a lithium salt, and a solvent with a high boiling point, and an electrochemical device comprising the electrolyte.

### BACKGROUND

Cyclic quaternary ammonium ionic liquids such as N-propyl-N-methylpyrrolidinium bis(fluorosulfonyl)imide (PYR13FSI) is a promising electrolyte solvent due to its solubility of lithium salt, excellent electrochemical and chemical stability, and negligible vapor pressure. However, when cyclic quaternary ammonium ionic liquid such as PYR13FSI is used without other electrolyte solvents, the resulting electrolyte has sluggish Li ion transport and poor rate capability at room temperature. Conventional organic solvents can improve the transport properties of the electrolytes so they can meet the criteria for practical applications and can also promote the formation of LiF-rich solid-electrolyte interface (SEI), which improves the stability of SEI and suppress Li dendrites. However, these conventional organic solvents exhibit a low boiling point (bp). For example, bis(2,2,2-trifluoroethyl) ether (BTFE), 1,1,2,2-tetrafluoroethyl 2,2,3,3-tetrafluoropropyl ether (TTE), and 1,2-dimethoxyethane (DME) have a boiling point of around 62° C., 92° C., and 85° C., respectively. When these conventional solvents are used as a solvent in electrolytes comprising PYR13FSI and LiFSI, the battery may exhibit a less desirable safety profile, especially when the battery experiences a high temperature due to self-heating or external heating. The leaking and venting of electrolyte components with low bp will release hazardous chemicals that are toxic and/or flammable. The leaking and venting process could also lead to explosion of the battery in certain circumstances. Thus, there remains a need for electrolytes with improved battery safety especially at elevated temperatures.

### SUMMARY

The present disclosure provides an electrolyte comprising a cyclic quaternary ammonium ionic liquid, a lithium salt, and an organic solvent with a high boiling point. In some embodiments, the organic solvent has a boiling point of at least 100° C. In some embodiments, the cyclic quaternary ammonium ionic liquid and the lithium salt have the same anion. In some embodiments, the cyclic quaternary ammonium ionic liquid is a pyrrolidinium ionic liquid, a piperidinium ionic liquid, an azepanium ionic liquid, an azocanium ionic liquid, an azonanium ionic liquid, or mixtures thereof. In some embodiments, the pyrrolidinium ionic liquid is N-propyl-N-methylpyrrolidinium bis(fluorosulfonyl)imide (PYR13FSI). In some embodiments, the lithium salt is lithium bis(fluorosulfonyl)imide. In some embodiments, the organic solvent is free of ionic structure. In one aspect, an electrochemical device, such as a lithium metal battery, comprising the electrolyte is also disclosed. In some embodiments, the battery exhibits an improved safety profile. Methods for preparing the electrolyte and the lithium metal battery are also disclosed.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows the cycling performance of Li/Li symmetric coin cell comprising Li metal as anode, microporous membrane as separator, another Li metal as cathode, and an electrolyte according to one embodiment of the present disclosure.

FIG. 2 shows the specific capacities and cycle life of pouch cell (0.75 Ah) comprising Li metal as anode, NMC811 composite electrode as cathode, microporous membrane as separator, and an electrolyte according to one embodiment of the present disclosure.

FIG. 3 shows the specific capacities at various charge rates (1.0 C=3.0 mA/cm², up to 7.5 mA/cm²) of coin cell comprising Li metal as anode, NMC811 composite electrode as cathode, microporous membrane as separator, and an electrolyte according to one embodiment of the present disclosure.

FIG. 4 shows the specific capacities and cycle life of pouch cell (0.75 Ah) comprising Li metal as anode, NMC811 composite electrode as cathode, microporous membrane as separator, and an electrolyte according to one embodiment of the present disclosure.

FIG. 5 shows the specific capacities at various charge rates (1.0 C=3.0 mA/cm², up to 7.5 mA/cm²) of coin cell comprising Li metal as anode, NMC811 composite electrode as cathode, microporous membrane as separator, and an electrolyte according to one embodiment of the present disclosure.

FIG. 6 shows the specific capacities and cycle life of pouch cell (0.75 Ah) comprising Li metal as anode, NMC811 composite electrode as cathode, microporous membrane as separator, and an electrolyte according to one embodiment of the present disclosure.

FIG. 7 shows the differential scanning calorimetry (DSC) measurement of electrolyte according to one embodiment of the present disclosure.

FIG. 8 shows the specific capacities and cycle life of pouch cell (0.75 Ah) comprising Li metal as anode, NMC811 composite electrode as cathode, microporous membrane as separator, and an electrolyte according to one embodiment of the present disclosure.

FIG. 9 shows the specific capacities and cycle life of pouch cell (0.75 Ah) comprising Li metal as anode, NMC811 composite electrode as cathode, microporous membrane as separator, and an electrolyte according to one embodiment of the present disclosure.

FIG. 10 shows the specific capacities and cycle life of pouch cell (0.75 Ah) comprising Li metal as anode, NMC811 composite electrode as cathode, microporous membrane as separator, and an electrolyte according to one embodiment of the present disclosure.

### DETAILED DESCRIPTION

Disclosed is an electrolyte comprising a cyclic quaternary ammonium ionic liquid, a lithium salt, and an organic solvent with a high boiling point. In some embodiments, the organic solvent has a boiling point of at least 100° C. In some embodiments, the cyclic quaternary ammonium ionic liquid and the lithium salt have the same anion. In some embodiments, the electrolyte and an electrochemical device comprising the same exhibit an improved thermal stability and safety, for example having suitable values for one or more of the following: ionic conductivity, average coulombic efficiency, and/or EUCAR (European Council for Automotive Research) hazard level after battery safety tests.

In some embodiments, the organic solvent with a high boiling point is not an inorganic or organic salt or an ionic liquid. In some embodiments, the organic solvent does not have an ionic structure. In some embodiments, the electrolyte does not comprise water.

In some embodiments, non-limiting specific organic solvents with a high boiling point (bp) above 100° C. include, but is not limited to, 1,2-diethoxyethane (DEE), 1,2-dipropoxyethane (DPE), dibutyl ether (DBE), diethylene glycol dimethyl ether (DGL), triethylene glycol dimethyl ether (triglyme), tetraethylene glycol dimethyl ether (tetraglyme), bis(2,2,2-trifluoroethoxy) methane (BTFM), 1H, 1H,5H-octafluoropentyl 1,1,2,2-tetrafluoroethyl ether (OTE), N,N-dimethyltrifluoromethanesulfonamide (DTSA), N,N-diethyltrifluoromethanesulfonamide (ETSA), 1,2-(1,1,2,2-tetrafluoroethoxy) ethane (TFEE), 1,2-bis(2,2-difluoroethoxy) ethane (BDFE), 2-[2-(2,2-difluoroethoxy) ethoxy]-1,1,1-trifluoroethane (DTFE), tris(2,2,2-trifluoroethyl) orthoformate (TFEO), tris(2,2,2-trifluoroethyl) phosphite (TFEPi), tris(2,2,2-trifluoroethyl) phosphate (TFEP), diethyl succinate (DESU), diethyl glutarate (DEGL), diethyl adipate (DEAD), diethyl sebacate (DES), trimethyl phosphate (TMP), triethyl phosphate (TEP), and mixtures thereof.

In some embodiments, the electrolyte comprises an organic solvent with a concentration in a range from 5 wt % to 70 wt %, from 5 wt % to 60 wt %, from 5 wt % to 50 wt %, from 5 wt % to 40 wt %, from 5 wt % to 30 wt %, from 5 wt % to 20 wt %, from 5 wt % to 10 wt %, from 7.5 wt % to 70 wt %, from 7.5 wt % to 60 wt %, from 7.5 wt % to 50 wt %, from 7.5 wt % to 40 wt %, from 7.5 wt % to 30 wt %, from 7.5 wt % to 20 wt %, from 7.5 wt % to 10 wt %, from 10 wt % to 70 wt %, from 10 wt % to 60 wt %, from 10 wt % to 50 wt %, from 10 wt % to 40 wt %, from 10 wt % to 30 wt %, from 10 wt % to 20 wt %, from 10 wt % to 15 wt %, or any and all ranges and subranges therebetween.

In some embodiments, the cyclic quaternary ammonium ionic liquid is a pyrrolidinium ionic liquid, a piperidinium ionic liquid, an azepanium ionic liquid, an azocanium ionic liquid, an azonanium ionic liquid, or mixtures thereof.

In some embodiments, the cyclic quaternary ammonium ionic liquid has a formula of

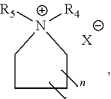

where n is an integer having a value in a range from 1 to 6, and R₁ and R₂ are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl or any combination thereof and X⁻ is an anion. Nonlimiting specific C₁₋₁₈ alkyls include methyl (—CH₃), ethyl (—CH₂CH₃), i-propyl (—CH(CH₃)₂), n-propyl (—CH₂CH₂CH₃), n-butyl (—CH₂ [CH₂]₂CH₃), i-butyl (—CH₂CH(CH₃)₂), n-pentyl (—CH₂ [CH₂]₃CH₃), n-hexyl (—CH₂ [CH₂]₄CH₃), n-heptyl (—CH₂ [CH₂]₅CH₃), n-octyl (—CH₂[CH₂]₆CH₃), n-nonyl (—CH₂[CH₂]₇CH₃), n-decyl (—CH₂[CH₂]₈CH₃), n-undecyl (—CH₂[CH₂]₉CH₃), n-dodecyl (—CH₂[CH₂]₁₀CH₃), n-tridecyl (—CH₂[CH₂]₁₁CH₃), n-tetradecyl (—CH₂[CH₂]₁₂CH₃), n-hexadecyl (—CH₂[CH₂]₁₄CH₃), n-octadecyl (—CH₂[CH₂]₁₆CH₃), and any combination thereof.

In some embodiments, the cyclic quaternary ammonium ionic liquid (IL) has a formula selected the of: from group consisting

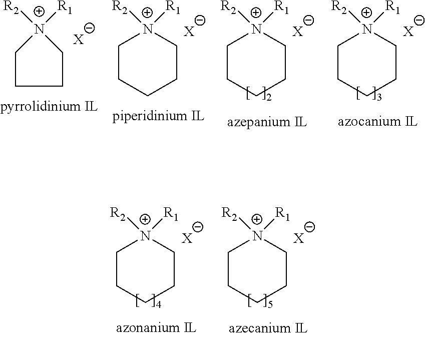

In some embodiments, the anion X is selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and a mixture thereof.

In some embodiments, the cyclic quaternary ammonium ionic liquids are selected from the group consisting of N-propyl-N-methylpyrrolidinium bis(fluorosulfonyl)imide (PYR13FSI), N-propyl-N-methylpyrrolidinium bis(trifluoromethanesulfonyl)imide (PYR13TFSI), 1-butyl-1-methylpyrrolidinium bis(fluorosulfonyl)imide (PYR14FSI), 1-butyl-1-methylpyrrolidinium bis(oxalate)borate (PYR14BOB), 1-butyl-1-methylpyrrolidinium bis(trifluoromethanesulfonyl)imide (PYR14TFSI), 1-butyl-1-methylpyrrolidinium dicyanamide (PYR14DCA), 1-butyl-1-methylpyrrolidinium trifluoromethanesulfonate (PYR14TfO), 1-methyl-1-(2-methoxyethyl) pyrrolidinium bis(fluorosulfonyl)imide (PYOFSI), 1-methyl-1-pentylpyrrolidinium bis(trifluoromethanesulfonyl)imide (PYR15TFSI), 1-methyl-1-octylpyrrolidinium bis(trifluoromethanesulfonyl)imide (PYR18TFSI), N-propyl-N-methylpiperidinium bis(fluorosulfonyl)imide, N-propyl-N-methylpiperidinium bis(trifluoromethanesulfonyl)imide, 1-butyl-1-methylpiperidinium bis(fluorosulfonyl)imide, 1-butyl-1-methylpiperidinium bis(oxalate)borate, 1-butyl-1-methylpiperidinium bis(trifluoromethanesulfonyl)imide, 1-butyl-1-methylpiperidinium dicyanamide, 1-butyl-1-methylpiperidinium trifluoromethanesulfonate, 1-methyl-1-(2-methoxyethyl) piperidinium bis(fluorosulfonyl)imide, 1-methyl-1-pentylpiperidinium bis(trifluoromethanesulfonyl)imide, 1-methyl-1-octylpiperidinium bis(trifluoromethanesulfonyl)imide, N-propyl-N-methylazepanium bis(fluorosulfonyl)imide, N-propyl-N-methylazepanium bis(trifluoromethanesulfonyl)imide, 1-butyl-1-methylazepanium bis(fluorosulfonyl)imide, 1-butyl-1-methylazepanium bis(oxalate)borate, 1-butyl-1-methylazepanium bis(trifluoromethanesulfonyl)imide, 1-butyl-1-methylazepanium dicyanamide, 1-butyl-1-methylazepanium trifluoromethanesulfonate, 1-methyl-1-(2-methoxyethyl) azepanium bis(fluorosulfonyl)imide, 1-methyl-1-pentylazepanium bis(trifluoromethanesulfonyl)imide, 1-methyl-1-octylazepanium bis(trifluoromethanesulfonyl)imide, and mixtures thereof.

In some embodiments, the electrolyte comprises a cyclic quaternary ammonium ionic liquid with a weight percentage in a range from 10 wt % to 80 wt %, from 10 wt % to 70 wt %, from 10 wt % to 60 wt %, from 10 wt % to 50 wt %, from 10 wt % to 40 wt %, from 10 wt % to 30 wt %, from 20 wt % to 80 wt %, from 20 wt % to 70 wt %, from 20 wt % to 60 wt %, from 20 wt % to 50 wt %, from 20 wt % to 40 wt %, from 20 wt % to 30 wt %, from 30 wt % to 80 wt %, from 30 wt % to 70 wt %, from 30 wt % to 60 wt %, from 30 wt % to 50 wt %, from 30 wt % to 40 wt %, from 35 wt % to 80 wt %, from 35 wt % to 70 wt %, from 35 wt % to 60 wt %, from 35 wt % to 50 wt %, from 35 wt % to 40 wt %, from 40 wt % to 80 wt %, from 40 wt % to 70 wt %, from 40 wt % to 60 wt %, from 40 wt % to 50 wt %, or any and all ranges and subranges therebetween.

In some embodiments, the lithium salt may comprise one or more lithium salts. In one embodiment, the lithium salts are selected from the group consisting of lithium bis(fluorosulfonyl)imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato) borate (LiBOB), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bis(perfluoroethanesulfonyl)imide (LiBETI), lithium difluoro(oxalato)borate (LiDFOB), lithium fluorophosphate (Li₂PO₃F), lithium difluoro (bisoxalato)phosphate (LiC₄PO₈F₂), lithium tetrafluoro (oxalato)phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, lithium acetate, lithium trifluoromethyl acetate, lithium oxalate, and a mixture thereof.

In some embodiments, the lithium salt comprises a first lithium salt and a second lithium salt, wherein the first lithium salt is different from the second lithium salt. In some embodiments, at least one of the first and second lithium salts shares the same anion as the cyclic quaternary ammonium ionic liquid. In some embodiments, the anion is FSI or TFSI.

In some embodiments, the electrolyte comprises a lithium salt with a concentration in a range from 10 wt % to 60 wt %, from 10 wt % to 55 wt %, from 10 wt % to 50 wt %, from 10 wt % to 40 wt %, from 10 wt % to 30 wt %, from 10 wt % to 20 wt %, from 12.5 wt % to 60 wt %, from 12.5 wt % to 50 wt %, from 12.5 wt % to 40 wt %, from 12.5 wt % to 30 wt %, from 12.5 wt % to 20 wt %, from 15 wt % to 60 wt %, from 15 wt % to 50 wt %, from 15 wt % to 40 wt %, from 15 wt % to 30 wt %, from 15 wt % to 20 wt %, from 17.5 wt % to 60 wt %, from 17.5 wt % to 50 wt %, from 17.5 wt % to 40 wt %, from 17.5 wt % to 30 wt %, from 17.5 wt % to 20 wt %, from 20 wt % to 60 wt %, from 20 wt % to 50 wt %, from 20 wt % to 40 wt %, from 20 wt % to 30 wt %, from 20 wt % to 25 wt %, or any and all ranges and subranges therebetween.

In some embodiments, the electrolyte may further comprise a second ionic liquid to improve the ionic conductivity, thermal stability, electrochemical performance or stability, and/or safety. In some embodiments, the second ionic liquid is a second cyclic quaternary ammonium ionic liquid. In some embodiments, the second ionic liquid is an imidazolium based ionic liquid has a formula of

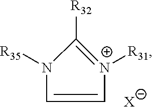

wherein where R₃₁ and R₃₃ are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₆₋₁₈ aryl, R₃₂ is selected from the group consisting of hydrogen, C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₆₋₁₈ aryl, and X⁻ is an anion comprising at least one selected from the group consisting of bis(fluorosulfonyl)imide (FSI⁻), bis(trifluoromethanesulfonyl)imide (TFSI), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), dicyanamide (DCA⁻), nitrate (NO₃⁻), fluoride (F⁻), chloride (Cl⁻), bromide (Br⁻), and a mixture thereof. Nonlimiting specific C₁₋₁₈ alkyls include methyl (—CH₃), ethyl (—CH₂CH₃), i-propyl (—CH(CH₃)₂), n-propyl (—CH₂CH₂CH₃), n-butyl (—CH₂[CH₂]₂CH₃), i-butyl (—CH₂CH(CH₃)₂), n-pentyl (—CH₂[CH₂]₃CH₃), n-hexyl (—CH₂[CH₂]₄CH₃), n-heptyl (—CH₂[CH₂]₈CH₃), n-octyl (—CH₂[CH₂]₆CH₃), n-nonyl (—CH₂[CH₂]₇CH₃), n-decyl (—CH₂[CH₂]₈CH₃), n-undecyl (—CH₂[CH₂]₉CH₃), n-dodecyl (—CH₂[CH₂]₁₀CH₃), n-tridecyl (—CH₂[CH₂]₁₁CH₃), n-tetradecyl (—CH₂[CH₂]₁₂CH₃), n-hexadecyl (—CH₂[CH₂]₁₄CH₃), n-octadecyl (—CH₂[CH₂]₁₆CH₃), and any combination thereof. In some embodiments, at least one of the cyclic quaternary ammonium ionic liquid and the second ionic liquid have the same anion as the lithium salt. In some embodiments, the anion is FSI or TFSI.

In some embodiments, the second ionic liquid comprises at least one selected from the group consisting of 1-ethyl-3-methylimidazolium bis(fluorosulfonyl)imide (EmimFSI), 1-butyl-3-methylimidazolium bis(fluorosulfonyl)imide (BmimFSI), 1-hexyl-3-methylimidazolium bis(fluorosulfonyl)imide (HmimFSI), 1-vinyl-3-methylimidazolium bis(fluorosulfonyl)imide (VmimFSI), 1-ethyl-3-methylimidazolium bis(trifluoromethanesulfonyl)imide (EmimTFSI), 1-butyl-3-methylimidazolium bis(trifluoromethanesulfonyl)imide (BmimTFSI), 1-hexyl-3-methylimidazolium bis(trifluoromethanesulfonyl)imide (HmimTFSI), 1-vinyl-3-methylimidazolium bis(trifluoromethanesulfonyl)imide (VmimTFSI), and mixtures thereof.

In some embodiments, the electrolyte comprises a second ionic liquid with a concentration in a range from 1.0 wt % to 30 wt %, from 1.0 wt % to 25 wt %, from 1.0 wt % to 20 wt %, from 1.0 wt % to 15 wt %, from 1.0 wt % to 10 wt %, from 1.0 wt % to 7.5 wt %, from 1.0 wt % to 5.0 wt %, from 1.0 wt % to 2.5 wt %, from 1.0 wt % to 2.0 wt %, from 2.0 wt % to 30 wt %, from 2.0 wt % to 25 wt %, from 2.0 wt % to 20 wt %, from 2.0 wt % to 15 wt %, from 2.0 wt % to 10 wt %, from 2.0 wt % to 7.5 wt %, from 2.0 wt % to 5.0 wt %, from 2.0 wt % to 2.5 wt %, from 5.0 wt % to 30 wt %, from 5.0 wt % to 25 wt %, from 5.0 wt % to 20 wt %, from 5.0 wt % to 15 wt %, from 5.0 wt % to 10 wt %, from 5.0 wt % to 7.5 wt %, or any and all ranges and subranges therebetween.

In some embodiments, the cyclic quaternary ammonium ionic liquid and the lithium salt share the same anion. In one embodiment, the organic solvent does not comprise ionic structure.

In some embodiments, the electrolyte comprises N-propyl-N-methylpyrrolidinium bis(fluorosulfonyl)imide (PYR13FSI), lithium bis(fluorosulfonyl)imide (LiFSI), and an organic solvent with a high boiling point.

In some embodiments, the organic solvent has a boiling point of no less than 100° C., no less than 105° C., no less than 110° C., no less than 120° C., no less than 130° C., no less than 140° C., no less than 150° C., no less than 160° C., no less than 170° C. or no less than 180° C. The boiling point is measured at 1 atm i.e., 760 mm Hg, unless otherwise specified. In some embodiment, each component in the electrolyte has a boiling point of at least 100° C., at least 105° C., at least 110° C., at least 120° C., at least 130° C., at least 140° C., at least 150° C., or at least 160° C.

In some embodiments, the electrolyte further comprises a polymer to improve the thermal stability and/or safety. In some embodiments, the polymer is added into a mixture containing a cyclic quaternary ammonium ionic liquid, a lithium salt, and an organic solvent with a high bp.

In some embodiments, the electrolyte comprises a polymer with a concentration in a range from 0.01 wt % to 20 wt %, from 0.01 wt % to 15 wt %, from 0.01 wt % to 10 wt %, from 0.01 wt % to 5.0 wt %, from 0.01 wt % to 2.0 wt %, from 0.01 wt % to 1.5 wt %, from 0.01 wt % to 1.0 wt %, from 0.05 wt % to 20 wt %, from 0.05 wt % to 15 wt %, from 0.05 wt % to 10 wt %, from 0.05 wt % to 5.0 wt %, from 0.05 wt % to 2.0 wt %, from 0.05 wt % to 1.5 wt %, from 0.05 wt % to 1.0 wt %, from 0.1 wt % to 20 wt %, from 0.1 wt % to 15 wt %, from 0.1 wt % to 10 wt %, from 0.1 wt % to 5.0 wt %, from 0.1 wt % to 2.0 wt %, from 0.1 wt % to 1.5 wt %, from 0.1 wt % to 1.0 wt %, from 0.25 wt % to 20 wt %, from 0.25 wt % to 15 wt %, from 0.25 wt % to 10 wt %, from 0.25 wt % to 5.0 wt %, from 0.25 wt % to 2.0 wt %, from 0.25 wt % to 1.5 wt %, from 0.25 wt % to 1.0 wt %, from 0.5 wt % to 20 wt %, from 0.5 wt % to 15 wt %, from 0.5 wt % to 10 wt %, from 0.5 wt % to 5.0 wt %, from 0.5 wt % to 2.0 wt %, from 0.5 wt % to 1.5 wt %, from 0.5 wt % to 1.0 wt %, or any and all ranges and subranges therebetween.

In some embodiments, the polymer is in situ polymerized after a monomer and initiator is mixed with a cyclic quaternary ammonium ionic liquid, a lithium salt, and the solvent. When an electrolyte comprises a polymer, the electrolyte is referred to as polymer electrolyte.

In some embodiments, the polymer electrolyte is prepared by an in situ polymerization in the presence of an initiator such as azobisisobutyronitrile (AIBN), ammonium persulfate (APS), potassium persulfate (PPS), sodium persulfate (SPS), and lithium persulfate (LPS). In some embodiments, the polymer electrolyte is prepared by an in situ polymerization in the presence of an initiator that does not generate gas during the polymerization. Such a non-gas generating initiator is an initiator that does not have any groups leading to gas formation during the polymerization.

In some embodiments, the initiator is a persulfate. In some embodiments, a persulfate initiator comprises an anion of SO₅²⁻, S₂O₈²⁻, or both. In some embodiments, non-limiting specific persulfate initiators include ammonium persulfate (APS), potassium persulfate (PPS), sodium persulfate (SPS), lithium persulfate (LPS) and any combination thereof. In some embodiments, the electrolyte composition does not include gas generating initiators, such as azobisisobutyronitrile (AIBN) and benzoyl peroxide (BPO).

In some embodiments, the mixture prior to in situ polymerization contains an initiator in an amount from 0.001 wt % to 10 wt %. In some embodiments, the mixture contains an initiator in an amount from 0.002 wt % to 10 wt %, from 0.005 wt % to 10 wt %, from 0.01 wt % to 10 wt %, from 0.02 wt % to 10 wt %, from 0.05 wt % to 10 wt %, from 0.1 wt % to 10 wt %, from 0.2 wt % to 10 wt %, from 0.5 wt % to 10 wt %, from 1.0 wt % to 10 wt %, from 2.0 wt % to 10 wt % or any and all ranges and subranges therebetween.

In some embodiments, the monomer contains one or more polymerizable groups. In some embodiments, non-limiting specific polymerizable groups include vinyl (—CH—CH₂), substituted vinyl (—CR₁═CR₂R₃) and a combination thereof, wherein R₁, R₂ and R₃ are independently hydrogen, halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl or any combination thereof. Non-limiting specific monomers include 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=500 to 5000), triethylene glycol dimethacrylate (TEGDMA), diurethane dimethacrylate, and any combination thereof.

In some embodiments, non-limiting monomers are one or more selected from tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl] isocyanurate (TAEI), di(trimethylolpropane) tetraacrylate (Di-TMPTA), trimethylolpropane propoxylate triacrylate, trimethylolpropane trimethacrylate, pentaerythritol triacrylate, and dipentaerythritol hexaacrylate.

In some embodiments, the polymer electrolyte is prepared from a mixture containing multiple monomers.

In some embodiments, the monomer is mixed with a lithium salt, a cyclic quaternary ammonium ionic liquid, and a solvent with a high boiling point to form a mixture. In some embodiments, the mixture contains the monomer with a concentration in a range from 0.01 wt % to 20 wt %, from 0.01 wt % to 15 wt %, from 0.01 wt % to 10 wt %, from 0.01 wt % to 5.0 wt %, from 0.01 wt % to 2.0 wt %, from 0.01 wt % to 1.5 wt %, from 0.01 wt % to 1.0 wt %, from 0.05 wt % to 20 wt %, from 0.05 wt % to 15 wt %, from 0.05 wt % to 10 wt %, from 0.05 wt % to 5.0 wt %, from 0.05 wt % to 2.0 wt %, from 0.05 wt % to 1.5 wt %, from 0.05 wt % to 1.0 wt %, from 0.1 wt % to 20 wt %, from 0.1 wt % to 15 wt %, from 0.1 wt % to 10 wt %, from 0.1 wt % to 5.0 wt %, from 0.1 wt % to 2.0 wt %, from 0.1 wt % to 1.5 wt %, from 0.1 wt % to 1.0 wt %, from 0.25 wt % to 20 wt %, from 0.25 wt % to 15 wt %, from 0.25 wt % to 10 wt %, from 0.25 wt % to 5.0 wt %, from 0.25 wt % to 2.0 wt %, from 0.25 wt % to 1.5 wt %, from 0.25 wt % to 1.0 wt %, from 0.5 wt % to 20 wt %, from 0.5 wt % to 15 wt %, from 0.5 wt % to 10 wt %, from 0.5 wt % to 5.0 wt %, from 0.5 wt % to 2.0 wt %, from 0.5 wt % to 1.5 wt %, from 0.5 wt % to 1.0 wt %, or any and all ranges and subranges therebetween.

In some embodiments, the electrolyte comprises 10 wt % to 40 wt % lithium salt, 20 wt % to 75 wt % cyclic quaternary ammonium ionic liquid, and 10 wt % to 50 wt % organic solvent with a high boiling point. In some embodiments, the solvent is a mixture comprising at least one solvent with a high boiling point (100° C. or higher).

In some embodiments, the electrolyte comprises 10 wt % to 40 wt % lithium bis(fluorosufonyl)imide (LiFSI) as lithium salt, 20 wt % to 75 wt % N-propyl-N-methylpyrrolidinium bis(fluorosulfonyl)imide (PYR13FSI) as cyclic quaternary ammonium ionic liquid, and 10 wt % to 50 wt % organic solvent with a boiling point of at least 100° C.

In one aspect, the present disclosure provides an electrochemical device such as lithium metal battery comprising the electrolyte. In some embodiments, the battery comprises a lithium metal anode, a separator, and a cathode.

In some embodiments, the electrolyte as disclosed herein exhibits a good ionic conductivity. In some embodiments, the electrolyte as disclosed herein exhibits an ionic conductivity of 1.0 mS/cm or higher, 2.0 mS/cm or higher, 2.5 mS/cm or higher, 3.0 mS/cm or higher, 3.5 mS/cm or higher, 4.0 mS/cm or higher, 4.5 mS/cm or higher, 5.0 mS/cm or higher, 5.5 mS/cm or higher, 6.0 mS/cm or higher, 6.5 mS/cm or higher, or 7.0 mS/cm or higher at room temperature.

In some embodiments, the electrolyte as disclosed herein exhibits an improved thermal stability in comparison to the one comprising a solvent with a boiling point of less than 100° C. In one embodiment, the electrolyte as disclosed herein does not exhibit any exothermic or endothermic peak in a differential scanning calorimetry (DSC) curve in a range from room temperature to 100° C. except that the peak at the beginning of DSC scanning is attributed to the equilibrium of the DSC system and is not related to the exothermic or endothermic peak of the electrolyte. Whether a reversible peak is exothermic or endothermic depends on the scanning direction. In one embodiment, the electrolyte as disclosed herein does not exhibit any exothermic or endothermic peak in a DSC curve in a range from room temperature to 105° C. In one embodiment, the electrolyte as disclosed herein does not exhibit any exothermic or endothermic peak in a DSC curve in a range from room temperature to 110° C.

In some embodiments, the electrolyte does not include any solvent that has a boiling point less than 100° C., less than 105° C., less than 110° C., or less than 120° C. In some embodiments, the electrolyte does not include bis(2,2,2-trifluoroethyl) ether (BTFE), 1,1,2,2-tetrafluoroethyl 2,2,3,3-tetrafluoropropyl ether (TTE) or 1,2-dimethoxyethane (DME).

In some embodiments, the electrolyte further comprises an additive with a weight percentage of 5.0 wt % or less. In some embodiments, the additive has a boiling point less than 100° C., less than 105° C., less than 110° C., or less than 120° C.

In one aspect, the present disclosure provides an electrochemical device such as lithium metal battery comprising the electrolyte. In some embodiments, the battery also comprises a lithium metal anode, a separator, and a cathode layer. In one embodiment, the lithium metal anode comprises lithium metal or an alloy of lithium metal. In some embodiments, the electrochemical device is a coin cell, a pouch cell, or a prismatic cell.

In some embodiments, an electrochemical device comprising the electrolyte exhibits an improved cycling performance. In some embodiments, the electrochemical device comprising an electrolyte disclosed herein has an average Coulombic efficiency (CE) of no less 98.00%, no less than 98.25%, no less than 98.50%, no less than 98.75%, no less than 99.00%, no less than 99.10%, no less than 99.15%, no less than 99.20%, no less than 99.25%, no less than 99.30%, or no less than 99.35%.

In some embodiments, an electrochemical device comprises an electrolyte with a good ionic conductivity and simultaneously exhibits a desirable average CE, which can be no less 98.00%, no less than 98.25%, no less than 98.50%, no less than 98.75%, no less than 99.00%, no less than 99.10%, no less than 99.15%, no less than 99.20%, no less than 99.25%, no less than 99.30%, or no less than 99.35%.

In one embodiment, an electrochemical device comprising the electrolyte as disclosed herein exhibits an improved thermal stability and safety. Out of many ways, battery safety can be characterized by a hot box test. In general, a fully charged electrochemical device (100% state-of-charge) is placed into an oven in which the temperature of the electrochemical device such as a cell is heated from room temperature to a desired high temperature (such as 190° C.) at a rate of 5° C./minute and with a holding of 10 min at each of the following temperatures: 130° C., 140° C., 150° C., 160° C., 170° C., 180° C., and 190° C.

In some embodiments, after the hot box test, the electrochemical device does not experience electrolyte leakage, weight loss, explosion, and/or has a European Council for Automotive Research (EUCAR) hazard level of 4 or below or 3 or below.

In some embodiments, after the hot box test, the electrochemical device undergoes a weight loss of 40 wt % or less, 45 wt % or less, or less than 50 wt % based on the total weight of electrolyte in the device.

In some embodiments, the electrochemical device passes a hotbox test with a European Council for Automotive Research (EUCAR) hazard level of 4 or below or 3 or below. The EUCAR hazard level is shown in Table 1.

TABLE 1
European Council for Automotive Research Hazard Levels

| Hazard | | |
|---|---|---|
| Level | Description | Classification Criteria |
| 0 | No effect | No effect. No loss of functionality |
| 1 | Passive | No defect; no leakage; no venting; no |
| | protection | fire or flame; no rupture; no explosion; |
| | activated | no exothermic reaction or thermal runaway. |
| | | Cell irreversibly damaged. Repair is needed |
| 2 | Defect/Damage | No leakage; no venting; no fire or flame; |
| | | no rupture; no explosion; no exothermic |
| | | reaction or thermal runaway. Cell |
| | | irreversibly damaged. Repair is needed |
| 3 | Leakage, Δ | No venting; no fire or flame; no rupture; |
| | mass <50% | no explosion; weight loss <50% of electrolyte |
| | | weight (electrolyte = salt + solvent) |
| 4 | Venting, Δ | No fire or flame; no rupture; no explosion; |
| | mass ≥50% | weight loss ≥50% of electrolyte weight |
| | | (electrolyte = salt + solvent) |
| 5 | Fire or Flame | No rupture; no explosion (e.g., no |
| | | flying parts) |
| 6 | Rupture | No explosion; but flying parts of |
| | | the active mass |
| 7 | Explosion | Explosion (e.g., disintegration of the cell) |

In another aspect, the present disclosure provides a method for preparing an electrochemical device comprising an electrolyte with an organic solvent with a boiling point of at least 100° C., at least 105° C., or at least 110° C. In some embodiments, all components in the electrolyte have a boiling point of at least 100° C., at least 105° C., or at least 110° C. In some embodiments, the electrochemical device comprises an anode layer, a separator, and a cathode layer. In some embodiments, the method comprises: mixing PYR13FSI, LiFSI, an organic solvent with a bp of at least 100° C. into an electrolyte.

In some embodiments, the disclosure provides a method for preparing an electrochemical device comprising an anode layer, a separator, a cathode layer, and an electrolyte as disclosed herein. In one embodiment, the method may comprise:
1) mixing a cyclic quaternary ammonium ionic liquid, a lithium salt, and an organic solvent with a high boiling point into an electrolyte;
2) placing the anode layer, the separator, and the cathode layer into an assembly;
3) injecting the electrolyte into the assembly, thus forming an electrochemical device comprising the anode layer, the separator, the cathode layer, and the electrolyte.

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### Example 1

Li stripping/plating coulombic efficiency (CE) is a critical parameter for the evaluation of electrolyte stability on Li metal anode. The Li stripping/plating CE was obtained by stripping/plating cycles in Li/Cu cells comprising Li metal as anode, Cu foil as cathode, microporous membrane as a separator, and an electrolyte with a composition in Table 2 prepared by mixing the lithium salt, the cyclic quaternary ammonium ionic liquid, and a fluorinated ether as the solvent. The lithium salt and the cyclic quaternary ammonium ionic liquid have the same anion, FSI in this example.

The ionic conductivity of the electrolyte is calculated based on the bulk resistance obtained by electrochemical impedance spectroscopy (EIS) measurements at room temperature. As shown in Table 2, electrolytes comprising bis(2,2,2-trifluoroethoxy) methane (BTFM) with a boiling point of 108-109° C. show high conductivity and high CE, which are crucial for fast charge and long cycle life of Li metal battery.

As shown in Table 2, the electrolytes of examples 1-1, 1-2, 1-3, and 1-4 exhibit an ionic conductivity (IC) of 5.11 mS/cm, 5.58 mS/cm, 4.88 mS/cm and 3.45 mS/cm, respectively. Lithium metal batteries comprising the electrolytes exhibit an average Coulombic efficiency (CE) of 99.17%, 99.00%, 99.39%, and 99.42%, respectively.

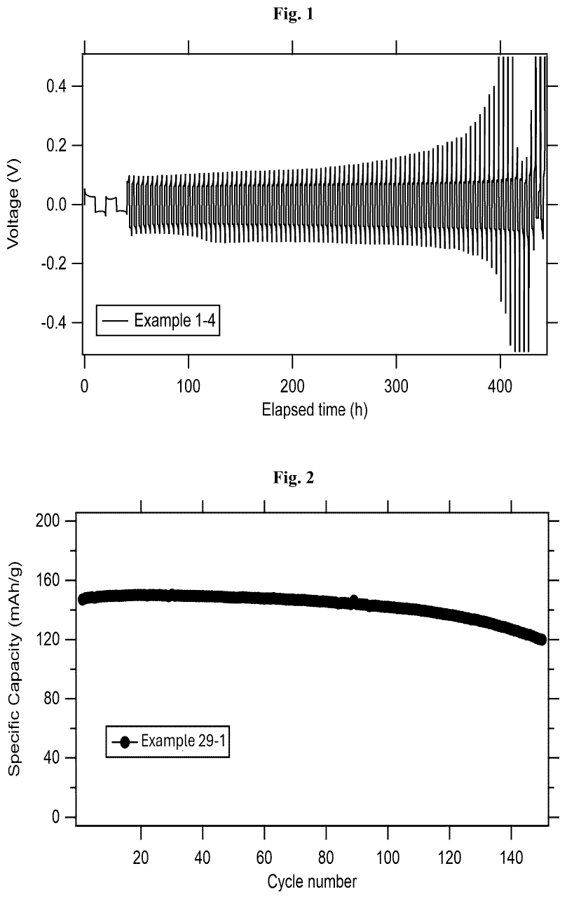

FIG. 1 shows the cycling performance of Li/Li symmetric coin cell comprising Li metal as anode, microporous membrane as separator, another Li metal as cathode, and an electrolyte of Example 1-4 (Ex. No. 1-4). The current density and capacity used for the Li/Li cycling are 1.5 mA/cm² and 3.0 mAh/cm², respectively.

TABLE 2
Electrolyte compositions according to some
embodiments of the present disclosure

| | | | | IC | | |
|---|---|---|---|---|---|---|
| Ex. | LiFSI | PYR13FSI | BTFM | (mS/ | Initial | Average |
| No. | (wt %) | (wt %) | (wt %) | cm) | CE (%) ^{a} | CE (%) ^{b} |
| 1-1 | 18.4 | 60.7 | 20.9 | 5.11 | 96.86 ± 0.36 | 99.17 ± 0.03 |
| 1-2 | 13.1 | 64.7 | 22.2 | 5.58 | 96.61 ± 0.06 | 99.00 ± 0.11 |
| 1-3 | 14.1 | 69.9 | 16.0 | 4.88 | 95.15 ± 0.63 | 99.39 ± 0.12 |
| 1-4 | 20.6 | 67.8 | 11.6 | 3.45 | 94.31 ± 0.14 | 99.42 ± 0.11 |

^{a} initial CE is initial Li stripping capacity divided by initial Li plating capacity.
^{b} average CE is total Li stripping cycle capacity divided by total Li plating cycle capacity using current density of 1.5 mA/cm² [Adv. Energy Mater. 2017, 1702097].

### Example 2

In this example, electrolytes were prepared and tested similar to Example 1 except that the compositions are shown in Table 3. The solvent is a non-fluorinated ether, 1,2-diethoxyethane (DEE) with a boiling point of 121° C.

As shown in Table 3, the electrolytes of examples 2-1, 2-2, 2-3, 2-4, 2-5, 2-6, and 2-7 exhibit an IC of 3.57 mS/cm, 4.75 mS/cm, 5.98 mS/cm, 7.96 mS/cm, 10.15 mS/cm, 10.59 mS/cm, and 5.24 mS/cm, respectively. Lithium metal batteries comprising the electrolytes exhibit an average CE of 99.43%, 99.24%, 99.34%, 99.41%, 99.50%, 99.33%, and 99.61% respectively.

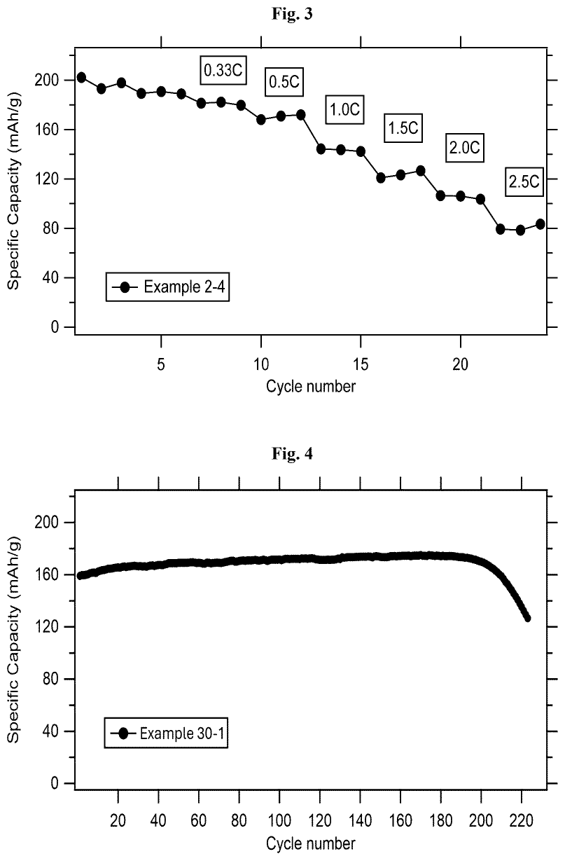

FIG. 3 shows the specific capacities at various charge rates (1.0 C=3.0 mA/cm², up to 7.5 mA/cm²) of a coin cell comprising Li metal as anode, NMC811 composite electrode as cathode, microporous membrane as separator, and an electrolyte of Example 2-4 (Ex. No. 2-4).

TABLE 3
Electrolyte compositions according to some
embodiments of the present disclosure

| | | | | IC | | |
|---|---|---|---|---|---|---|
| Ex | LiFSI | PYR13FSI | DEE | (mS/ | Initial | Average |
| No. | (wt %) | (wt %) | (wt %) | cm) | CE (%) | CE (%) |
| 2-1 | 37.4 | 50.1 | 12.5 | 3.57 | 94.50 ± 1.26 | 99.43 ± 0.09 |
| 2-2 | 37.4 | 43.8 | 18.8 | 4.75 | 95.85 ± 0.49 | 99.24 ± 0.04 |
| 2-3 | 37.4 | 37.6 | 25.0 | 5.98 | 95.13 ± 0.57 | 99.34 ± 0.05 |
| 2-4 | 37.4 | 31.3 | 31.2 | 7.96 | 95.85 ± 0.22 | 99.41 ± 0.04 |
| 2-5 | 34.4 | 32.8 | 32.8 | 10.15 | 95.46 ± 0.29 | 99.50 ± 0.06 |
| 2-6 | 32.8 | 33.6 | 33.6 | 10.59 | 94.08 ± 0.79 | 99.33 ± 0.16 |
| 2-7 | 40.0 | 40.0 | 20.0 | 5.24 | 94.21 ± 1.52 | 99.61 ± 0.15 |

The results of examples 2-1 through 2-4 show that the amount of the organic solvent plays a critical role in influencing the ion transportation. The results suggest that when the amount of the organic solvent is relatively low such as 12.5 wt % and 18.8 wt %, the electrolytes exhibit a worse ionic conductivity. In some embodiments, the weight percentage of the organic solvent is in a range from 20 wt % to 40 wt % in the electrolyte.

### Example 3

In this example, electrolytes were prepared and tested similar to Example 1 except that the compositions are shown in Table 4. The solvent is a mixture comprising a non-fluorinated ether and a fluorinated ether. In this example, the solvent comprises DEE and BTFM.

TABLE 4
Electrolyte compositions according to some
embodiments of the present disclosure

| Ex. | LiFSI | PYR13FSI | DEE | BTFM | IC | Initial CE | Average CE |
|---|---|---|---|---|---|---|---|
| No. | (wt %) | (wt %) | (wt %) | (wt %) | (mS/cm) | (%) | (%) |
| 3-1 | 33.7 | 45.1 | 11.2 | 10.0 | 2.96 | 94.91 ± 1.10 | 99.51 ± 0.17 |
| 3-2 | 30.0 | 40.0 | 10.0 | 20.0 | 3.12 | 94.91 ± 1.39 | 99.34 ± 0.14 |
| 3-3 | 29.0 | 38.8 | 9.7 | 22.5 | 7.92 | 93.36 ± 1.53 | 99.41 ± 0.11 |
| 3-4 | 25.0 | 30.0 | 20.0 | 25.0 | 9.80 | 95.03 ± 0.33 | 99.51 ± 0.02 |
| 3-5 | 26.2 | 21.9 | 21.9 | 30.0 | 8.84 | 95.09 ± 0.57 | 99.54 ± 0.04 |
| 3-6 | 37.6 | 18.7 | 18.7 | 25.0 | 5.02 | 95.54 ± 0.37 | 99.37 ± 0.03 |

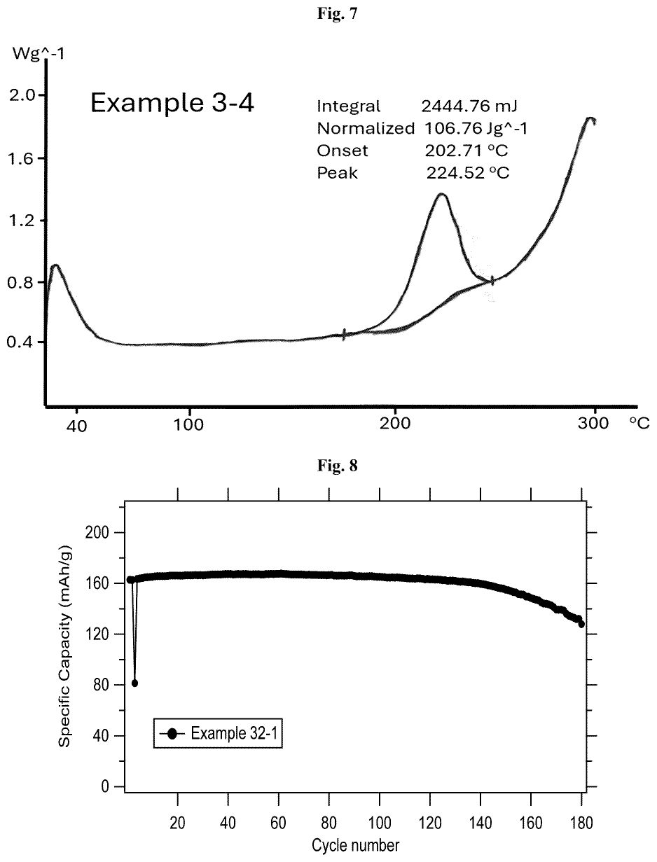

A differential scanning calorimetry (DSC) analysis was also conducted by scanning from 25 to 300° C. at a rate of 5° C./min in an atmosphere of Argon. FIG. 7 shows a DSC curve of an electrolyte of Example 3-4 (Ex. No. 3-4). There is no obvious exothermic or endothermic peak observed below 200° C. It strongly suggests an improved thermal stability of the electrolyte. The peak at the beginning of DSC scanning is attributed to the equilibrium of the DSC system and it is not related to the exothermic or endothermic peak of the electrolyte.

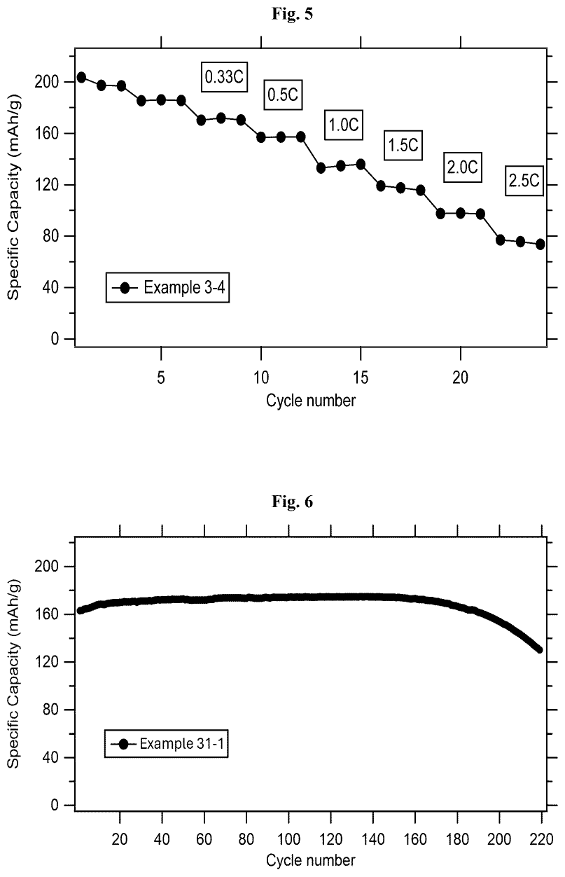

FIG. 5 shows the specific capacities at various charge rates (1.0 C=3.0 mA/cm², up to 7.5 mA/cm²) of a coin cell comprising Li metal as anode, NMC811 composite electrode as cathode, microporous membrane as separator, and an electrolyte of Example 3-4 (Ex. No. 3-4).

As shown in Table 4, the electrolytes of examples 3-1, 3-2, 3-3, 3-4, 3-5, and 3-6 exhibit an IC of 2.96 mS/cm, 3.12 mS/cm, 7.92 mS/cm, 9.80 mS/cm, 8.84 mS/cm, and 5.02 mS/cm, respectively. Lithium metal batteries comprising the electrolytes exhibit an average CE of 99.51%, 99.34%, 99.41%, 99.51%, 99.54%, and 99.37%, respectively.

The results in Table 4 show that the amount of the organic mixture solvent plays a critical role in influencing the ion transportation. The results suggest that when the amount of the mixture solvent is relatively low such as 21.2 wt % and 30.0 wt % in examples 3-1 and 3-2, respectively, the electrolytes exhibit a worse ionic conductivity. In some embodiments, the weight percentage of the mixture solvent is in a range from 35 wt % to 60 wt % in the electrolyte.

### Example 4

In this example, electrolytes were prepared and tested similar to Example 1 except that the compositions are shown in Table 5. The solvent comprises a non-fluorinated ether (DEE) and a fluorinated ether, i.e., 1H,1H,5H-octafluoropentyl 1,1,2,2-tetrafluoroethyl ether (OTE, with a boiling point of 133° C.).

As shown in Table 5, the electrolytes of examples 4-1, 4-2, 4-3, and 4-4 exhibit an IC of 5.44 mS/cm, 5.40 mS/cm, 3.89 mS/cm, and 3.14 mS/cm, respectively. Lithium metal battery comprising the electrolytes exhibit an average CE of 99.38%, 99.40%, 99.46%, and 99.52%, respectively.

TABLE 5
Electrolyte compositions according to some
embodiments of the present disclosure

| Ex. | LiFSI | PYR13FSI | DEE | OTE | IC | Initial CE | Average CE |
|---|---|---|---|---|---|---|---|
| No. | (wt %) | (wt %) | (wt %) | (wt %) | (mS/cm) | (%) | (%) |
| 4-1 | 25.0 | 30.0 | 20 | 25 | 5.44 | 95.75 ± 0.55 | 99.38 ± 0.06 |
| 4-2 | 30.0 | 22.5 | 22.5 | 25.0 | 5.40 | 96.03 ± 0.80 | 99.40 ± 0.17 |
| 4-3 | 33.8 | 20.6 | 20.6 | 25.0 | 3.89 | 95.90 ± 0.20 | 99.46 ± 0.10 |
| 4-4 | 37.6 | 18.7 | 18.7 | 25.0 | 3.14 | 95.48 ± 0.50 | 99.52 ± 0.06 |

### Example 5

In this example, electrolytes were prepared and tested similar to Example 1 except that the compositions are shown in Table 6. The solvent is a nonfluorinated ether, diethylene glycol dimethyl ether (DGL) with a boiling point of 162° C.

TABLE 6
Electrolyte compositions according to some
embodiments of the present disclosure

| | | | | IC | | |
|---|---|---|---|---|---|---|
| Ex. | LiFSI | PYR13FSI | DGL | (mS/ | Initial | Average |
| No. | (wt %) | (wt %) | (wt %) | cm) | CE (%) | CE (%) |
| 5-1 | 37.4 | 50.1 | 12.5 | 2.33 | 94.64 ± 0.23 | 99.55 ± 0.11 |
| 5-2 | 37.4 | 43.8 | 18.8 | 2.87 | 93.25 ± 2.40 | 99.19 ± 0.14 |
| 5-3 | 37.4 | 31.3 | 31.3 | 3.67 | 93.40 ± 1.42 | 99.37 ± 0.06 |

As shown in Table 6, the electrolytes of examples 5-1, 5-2, and 5-3 exhibit an IC of 2.33 mS/cm, 2.87 mS/cm, and 3.67 mS/cm, respectively. Lithium metal batteries comprising the electrolytes exhibit an average CE of 99.55%, 99.19%, and 99.37%, respectively.

### Example 6

In this example, electrolytes were prepared and tested similar to Example 1 except that the compositions are shown in Table 7. The solvent is a sulfonamide with a fluoroalkyl, N,N-diethyl-1,1,1-trifluoromethanesulfonamide (ETSA) with a boiling point of 178-180° C.

As shown in Table 7, the electrolytes of examples 6-1 and 6-2 exhibit an IC of 1.00 mS/cm and 0.99 mS/cm, respectively. Lithium metal batteries comprising the electrolytes exhibit an average CE of 99.18% and 99.23%, respectively.

TABLE 7
Electrolyte compositions according to some
embodiments of the present disclosure

| | | | | IC | | |
|---|---|---|---|---|---|---|
| Ex | LiFSI | PYR13FSI | ETSA | (mS/ | Initial | Average |
| No. | (wt %) | (wt %) | (wt %) | cm) | CE (%) | CE (%) |
| 6-1 | 37.4 | 37.6 | 25.0 | 1.00 | 96.40 ± 0.34 | 99.18 ± 0.05 |
| 6-2 | 37.4 | 31.3 | 31.3 | 0.99 | 95.94 ± 0.88 | 99.23 ± 0.02 |

### Example 7

In this example, electrolyte was prepared and tested similar to Example 1 except that the composition is shown in Table 8. The cyclic quaternary ammonium ionic liquid is N-propyl-N-methylpiperidinium bis(fluorosulfonyl)imide (PP13FSI) and the solvent is a fluorinated ether, BTFM.

As shown in Table 8, the electrolyte of example 7-1 exhibits an IC of 2.99 mS/cm. Lithium metal battery comprising the electrolyte exhibits an average CE of 98.00%.

TABLE 8
Electrolyte composition according to some
embodiments of the present disclosure

| | | | | IC | | |
|---|---|---|---|---|---|---|
| Ex. | LiFSI | PP13FSI | BTFM | (mS/ | Initial | Average |
| No. | (wt %) | (wt %) | (wt %) | cm) | CE (%) | CE (%) |
| 7-1 | 19.9 | 68.7 | 11.4 | 2.99 | 95.11 ± 0.37 | 98.00 ± 0.68 |

### Example 8

In this example, electrolyte was prepared and tested similar to Example 1 except that the composition is shown in Table 9, wherein a non-fluorinated ether DEE is the solvent. The electrolyte comprises two ionic liquids, i.e., PYR13FSI and PP13FSI. The lithium salt and both ionic liquids have the same anion.

TABLE 9
Electrolyte composition according to some embodiments of the present disclosure

| Ex. | LiFSI | PYR13FSI | PP13FSI | DEE | IC | Initial CE | Average CE |
|---|---|---|---|---|---|---|---|
| No. | (wt %) | (wt %) | (wt %) | (wt %) | (mS/cm) | (%) | (%) |
| 8-1 | 37.4 | 25.8 | 26.9 | 9.9 | 2.95 | 95.74 ± 0.70 | 99.37 ± 0.04 |

As shown in Table 9, the electrolyte of example 8-1 exhibits an ionic conductivity (IC) of 2.95 mS/cm. Lithium metal battery comprising the electrolyte exhibits an average Coulombic efficiency (CE) of 99.37%.

By comparing Example 8-1 with example 2, the incorporation of a second ionic liquid can lead to a high average CE with a good consistency, i.e., a low deviation.

### Example 9

In this example, electrolyte was prepared and tested similar to Example 1 except that the composition is shown in Table 10. The solvent comprises DEE and tris(2,2,2-trifluoroethyl) orthoformate (TFEO) with a boiling point of 144-146° C.

TABLE 10
Electrolyte composition according to some embodiments of the present disclosure

| Ex. | LiFSI | PYR13FSI | DEE | TFEO | IC | Initial CE | Average CE |
|---|---|---|---|---|---|---|---|
| No. | (wt %) | (wt %) | (wt %) | (wt %) | (mS/cm) | (%) | (%) |
| 9-1 | 25.0 | 30.0 | 20.0 | 25.0 | 6.93 | 95.94 ± 0.52 | 99.27 ± 0.05 |

As shown in Table 10, the electrolyte of example 9-1 exhibits an IC of 6.93 mS/cm. Lithium metal battery comprising the electrolyte exhibits an average CE of 99.27%.

### Example 10

In this example, electrolytes were prepared and tested similar to Example 1 except that the compositions are shown in Table 11. The solvent is a fluorinated ether, 1,2-(1,1,2,2-tetrafluoroethoxy) ethane (TFEE) with a boiling point of 141° C.

As shown in Table 11, the electrolytes of examples 10-1, 10-2, 10-3, and 10-4 exhibit an ionic conductivity (IC) of 2.40 mS/cm, 4.72 mS/cm, 4.16 mS/cm, and 3.66 mS/cm, respectively. Lithium metal batteries comprising the electrolytes exhibit an average Coulombic efficiency (CE) of 99.53%, 99.33%, 99.30%, and 99.00%, respectively.

TABLE 11
Electrolyte compositions according to some
embodiments of the present disclosure

| | | | | IC | | |
|---|---|---|---|---|---|---|
| Ex. | LiFSI | PYR13FSI | TFEE | (mS/ | Initial | Average |
| No. | (wt %) | (wt %) | (wt %) | cm) | CE (%) | CE (%) |
| 10-1 | 33.7 | 56.3 | 10.0 | 2.40 | 94.30 ± 0.33 | 99.53 ± 0.04 |
| 10-2 | 16.1 | 53.9 | 30.0 | 4.72 | 94.08 ± 0.79 | 99.33 ± 0.16 |
| 10-3 | 19.1 | 50.9 | 30.0 | 4.16 | 94.33 ± 1.44 | 99.30 ± 0.07 |
| 10-4 | 22.3 | 47.7 | 30.0 | 3.66 | 92.46 ± 1.81 | 99.00 ± 0.47 |

### Example 11

In this example, electrolyte was prepared and tested similar to Example 1 except that the composition is shown in Table 12. The solvent is a mixture of a non-fluorinated ether and a fluorinated ether and comprises DEE and TFEE.

TABLE 12
Electrolyte composition according to some embodiments of the present disclosure

| Ex. | LiFSI | PYR13FSI | DEE | TFEE | IC | Initial CE | Average CE |
|---|---|---|---|---|---|---|---|
| No. | (wt %) | (wt %) | (wt %) | (wt %) | (mS/cm) | (%) | (%) |
| 11-1 | 26.2 | 21.9 | 21.9 | 30.0 | 7.50 | 95.07 ± 0.80 | 99.41 ± 0.08 |

As shown in Table 12, the electrolyte of example 11-1 exhibits an IC of 7.50 mS/cm.

Lithium metal battery comprising the electrolyte exhibits an average CE of 99.41%.

### Example 12

In this example, electrolytes were prepared and tested similar to Example 1 except that the compositions are shown in Table 13. The solvent is a fluorinated ether, 1,2-bis(2,2-difluoroethoxy) ethane (BDFE) with a boiling point of 173° C.

As shown in Table 13, the electrolytes of examples 12-1, 12-2, 12-3, 12-4, and 12-5 exhibit an IC of 2.73 mS/cm, 6.64 mS/cm, 4.60 mS/cm, 3.23 mS/cm, and 3.35 mS/cm, respectively. Lithium metal batteries comprising the electrolytes exhibit an average CE of 99.50%, 99.31%, 99.36%, 99.12%, and 99.30%, respectively.

TABLE 13
Electrolyte compositions according to some
embodiments of the present disclosure

| | | | | IC | | |
|---|---|---|---|---|---|---|
| Ex. | LiFSI | PYR13FSI | BDFE | (mS/ | Initial | Average |
| No. | (wt %) | (wt %) | (wt %) | cm) | CE (%) | CE (%) |
| 12-1 | 32.8 | 33.6 | 33.6 | 2.73 | 95.71 ± 0.95 | 99.50 ± 0.20 |
| 12-2 | 23.0 | 38.5 | 38.5 | 6.64 | 97.47 ± 0.28 | 99.31 ± 0.04 |
| 12-3 | 25.0 | 30.0 | 45.0 | 4.60 | 95.87 ± 0.77 | 99.36 ± 0.06 |
| 12-4 | 32.0 | 27.0 | 41.0 | 3.23 | 95.69 ± 0.10 | 99.12 ± 0.22 |
| 12-5 | 32.0 | 20.0 | 48.0 | 3.35 | 96.37 ± 0.32 | 99.30 ± 0.05 |

### Example 13

In this example, electrolytes were prepared and tested similar to Example 1 except that the compositions are shown in Table 14. The solvent comprises a non-fluorinated ether, DEE, and a fluorinated ether, BDFE.

TABLE 14
Electrolyte compositions according to some
embodiments of the present disclosure

| Ex. | LiFSI | PYR13FSI | DEE | BDFE | IC | Initial CE | Average CE |
|---|---|---|---|---|---|---|---|
| No. | (wt %) | (wt %) | (wt %) | (wt %) | (mS/cm) | (%) | (%) |
| 13-1 | 32.0 | 20.0 | 20.0 | 28.0 | 7.54 | 96.74 ± 0.25 | 99.26 ± 0.03 |
| 13-2 | 32.0 | 30.0 | 18.0 | 20.0 | 7.58 | 95.95 ± 0.53 | 99.31 ± 0.06 |
| 13-3 | 35.0 | 20.0 | 20.0 | 25.0 | 6.37 | 96.51 ± 0.15 | 99.32 ± 0.06 |

As shown in Table 14, the electrolytes of examples 13-1, 13-2, and 13-3 exhibit an IC of 7.54 mS/cm, 7.58 mS/cm, and 6.37 mS/cm, respectively. Lithium metal batteries comprising the electrolytes exhibit an average CE of 99.26%, 99.31%, and 99.32%, respectively.

### Example 14

In this example, electrolytes were prepared and tested similar to Example 1 except that the compositions are shown in Table 15. The solvent comprises a first fluorinated ether, BDFE, and a second fluorinated ether, BTFM.

TABLE 15
Electrolyte compositions according to some
embodiments of the present disclosure

| Ex. | LiFSI | PYR13FSI | BDFE | BTFM | IC | Initial CE | Average CE |
|---|---|---|---|---|---|---|---|
| No. | (wt %) | (wt %) | (wt %) | (wt %) | (mS/cm) | (%) | (%) |
| 14-1 | 25.0 | 30.0 | 20.0 | 25.0 | 3.95 | 96.86 ± 0.61 | 99.16 ± 0.08 |
| 14-2 | 26.0 | 26.0 | 18.0 | 30.0 | 1.60 | 95.34 ± 0.54 | 99.20 ± 0.05 |
| 14-3 | 25.0 | 30.0 | 30.0 | 15.0 | 4.63 | 96.22 ± 0.94 | 99.34 ± 0.04 |
| 14-4 | 28.0 | 30.0 | 27.0 | 15.0 | 3.66 | 95.92 ± 0.55 | 99.27 ± 0.16 |

As shown in Table 15, the electrolytes of examples 14-1, 14-2, 14-3, and 14-4 exhibit an ionic conductivity (IC) of 3.95 mS/cm, 1.60 mS/cm, 4.63 mS/cm, and 3.66 mS/cm, respectively. Lithium metal batteries comprising the electrolytes exhibit an average Coulombic efficiency (CE) of 99.16%, 99.20%, 99.34%, 99.27%, respectively.

### Example 15

In this example, electrolytes were prepared and tested similar to Example 1 except that the compositions are shown in Table 16. The solvent is a first fluorinated ether, BDFE, and a second fluorinated ether, TFEO.

TABLE 16
Electrolyte compositions according to some
embodiments of the present disclosure

| Ex. | LiFSI | PYR13FSI | BDFE | TFEO | IC | Initial CE | Average CE |
|---|---|---|---|---|---|---|---|
| No. | (wt %) | (wt %) | (wt %) | (wt %) | (mS/cm) | (%) | (%) |
| 15-1 | 25.0 | 30.0 | 30.0 | 15.0 | 3.84 | 96.58 ± 0.67 | 99.22 ± 0.18 |
| 15-2 | 28.0 | 30.0 | 27.0 | 15.0 | 3.40 | 96.20 ± 0.62 | 99.20 ± 0.14 |

As shown in Table 16, the electrolytes of examples 15-1 and 15-2 exhibit an IC of 3.84 mS/cm and 3.40 mS/cm, respectively. Lithium metal batteries comprising the electrolytes exhibit an average CE of 99.22 and 99.20%, respectively.

### Example 16

In this example, electrolytes were prepared and tested similar to Example 1 except that the compositions are shown in Table 17. The solvent is 2-[2-(2,2-difluoroethoxy) ethoxy]-1,1,1-trifluoroethane (DTFE) with a boiling point of 75° C. at 25 mm Hg (expected to have a bp higher than 100° C. at 760 mm Hg).

As shown in Table 17, the electrolytes of examples 16-1, 16-2, and 16-3 exhibit an IC of 5.07 mS/cm, 3.94 mS/cm, and 2.81 mS/cm, respectively. Lithium metal batteries comprising the electrolytes exhibit an average CE of 99.28%, 99.30%, and 99.29%, respectively.

TABLE 17
Electrolyte compositions according to some
embodiments of the present disclosure

| | | | | IC | | |
|---|---|---|---|---|---|---|
| Ex. | LiFSI | PYR13FSI | DTFE | (mS/ | Initial | Average |
| No. | (wt %) | (wt %) | (wt %) | cm) | CE (%) | CE (%) |
| 16-1 | 22.0 | 39.0 | 39.0 | 5.07 | 96.21 ± 0.51 | 99.28 ± 0.04 |
| 16-2 | 25.0 | 30.0 | 45.0 | 3.94 | 95.78 ± 0.86 | 99.30 ± 0.07 |
| 16-3 | 32.0 | 34.0 | 34.0 | 2.81 | 95.12 ± 0.84 | 99.29 ± 0.12 |

### Example 17

In this example, electrolytes were prepared and tested similar to Example 1 except that the compositions are shown in Table 18. The solvent comprises a non-fluorinated ether, DEE, a first fluorinated ether, BDFE, and a second fluorinated ether, DTFE.

As shown in Table 18, the electrolytes of examples 17-1, 17-2, and 17-3 exhibit an IC of 6.96 mS/cm, 6.10 mS/cm, and 4.50 mS/cm, respectively. Lithium metal battery comprising the electrolytes exhibit an average CE of 99.18%, 99.26%, and 99.21%, respectively.

TABLE 18
Electrolyte compositions according to some embodiments of the present disclosure

| Ex. | LiFSI | PYR13FSI | DEE | BDFE | DTFE | IC | Initial CE | Average CE |
|---|---|---|---|---|---|---|---|---|
| No. | (wt %) | (wt %) | (wt %) | (wt %) | (wt %) | (mS/cm) | (%) | (%) |
| 17-1 | 32.0 | 20.0 | 16.0 | 16.0 | 16.0 | 6.96 | 96.14 ± 0.22 | 99.18 ± 0.08 |
| 17-2 | 32.0 | 30.0 | 14.0 | 12.0 | 12.0 | 6.10 | 96.02 ± 0.31 | 99.26 ± 0.06 |
| 17-3 | 35.0 | 20.0 | 15.0 | 15.0 | 15.0 | 4.50 | 96.35 ± 0.20 | 99.21 ± 0.10 |

### Example 18

In this example, electrolytes were prepared and tested similar to Example 1 except that the compositions are shown in Table 19. The solvent is a non-fluorinated ether, ethylene glycol dibutyl ether (DBE) with a boiling point of 202° C.

As shown in Table 19, the electrolytes of examples 18-1, 18-2, and 18-3 exhibit an IC of 2.95 mS/cm, 2.37 mS/cm, and 3.27 mS/cm, respectively. Lithium metal batteries comprising the electrolytes exhibit an average CE of 98.96%, 99.00%, and 99.10%, respectively.

TABLE 19
Electrolyte compositions according to some
embodiments of the present disclosure

| | | | | IC | | |
|---|---|---|---|---|---|---|
| Ex. | LiFSI | PYR13FSI | DBE | (mS/ | Initial | Average |
| No. | (wt %) | (wt %) | (wt %) | cm) | CE (%) | CE (%) |
| 18-1 | 35.0 | 32.5 | 32.5 | 2.95 | 93.00 ± 1.36 | 98.96 ± 0.02 |
| 18-2 | 38.0 | 31.0 | 31.0 | 2.37 | 93.49 ± 1.44 | 99.00 ± 0.23 |
| 18-3 | 35.0 | 30.0 | 35.0 | 3.27 | 92.02 ± 0.39 | 99.10 ± 0.07 |

### Example 19

In this example, electrolyte was prepared and tested similar to Example 1 except that the composition is shown in Table 20. The lithium salt comprises a first lithium salt, LiFSI, and a second lithium salt, LiTFSI.

As shown in Table 20, the electrolyte of example 19-1 exhibits an ionic conductivity of 8.73 mS/cm. Lithium metal battery comprising the electrolyte exhibits an average Coulombic efficiency (CE) of 99.14%.

TABLE 20
Electrolyte composition according to some embodiments of the present disclosure

| Ex. | LiFSI | LiTFSI | PYR13FSI | DEE | BTFM | IC | Initial CE | Average CE |
|---|---|---|---|---|---|---|---|---|
| No. | (wt %) | (wt %) | (wt %) | (wt %) | (%) | (mS/cm) | (%) | (%) |
| 19-1 | 20.0 | 5.0 | 30.0 | 20.0 | 25.0 | 8.73 | 95.78 ± 0.48 | 99.14 ± 0.03 |

In some embodiments, the first lithium salt with FSI as the anion is the major lithium salt and has a weight percentage of at least 60 wt %, at least 70 wt %, or at least 80 wt % in the lithium salt to ensure the stability of the electrolyte.

### Example 20

In this example, electrolytes were prepared and tested similar to Example 1 except that the compositions are shown in Table 21. The solvent is trimethyl phosphate (TMP) with a boiling point of 197° C. In addition to the thermal stability, TMP is a flame-retardant.

TABLE 21
Electrolyte compositions according to some
embodiments of the present disclosure

| | | | | IC | | |
|---|---|---|---|---|---|---|
| Ex. | LiFSI | PYR13FSI | TMP | (mS/ | Initial | Average |
| No. | (wt %) | (wt %) | (wt %) | cm) | CE (%) | CE (%) |
| 20-1 | 37.5 | 50.0 | 12.5 | 1.47 | 94.16 ± 0.70 | 99.12 ± 0.11 |
| 20-2 | 32.7 | 53.8 | 13.5 | 1.77 | 94.08 ± 0.74 | 98.97 ± 0.05 |

As shown in Table 21, the electrolytes of examples 20-1 and 20-2 exhibit an ionic conductivity of 1.47 mS/cm and 1.77 mS/cm, respectively. Lithium metal batteries comprising the electrolytes exhibit an average CE of 99.12% and 98.97%, respectively.

### Example 21

In this example, electrolyte was prepared and tested similar to Example 1 except that the composition is shown in Table 22. The ionic liquid is 1-methyl-1-(2-methoxyethyl) pyrrolidinium bis(fluorosulfonyl)imide (PYOFSI). A non-fluorinated ether, DEE, is the organic solvent.

As shown in Table 22, the electrolyte of example 21-1 exhibits an IC of 3.78 mS/cm. Lithium metal battery comprising the electrolyte exhibits an average CE of 99.39%.

TABLE 22
Electrolyte composition according to some
embodiments of the present disclosure

| | | | | IC | | |
|---|---|---|---|---|---|---|
| Ex. | LiFSI | PYOFSI | DEE | (mS/ | Initial | Average |
| No. | (wt %) | (wt %) | (wt %) | cm) | CE (%) | CE (%) |
| 21-1 | 37.5 | 50.0 | 12.5 | 3.78 | 95.77 ± 1.13 | 99.39 ± 0.05 |

### Example 22

In this example, electrolyte was prepared and tested similar to Example 1 except that the composition is shown in Table 23. The ionic liquid is 1-methyl-1-(2-methoxyethyl) pyrrolidinium bis(fluorosulfonyl)imide (PYOFSI) and the solvent comprises a non-fluorinated ether, DEE, and a fluorinated ether, BTFM.

TABLE 23
Electrolyte composition according to some embodiments of the present disclosure

| Ex. | LiFSI | PYOFSI | DEE | BTFM | IC | Initial CE | Average CE |
|---|---|---|---|---|---|---|---|
| No. | (wt %) | (wt %) | (wt %) | (wt %) | (mS/cm) | (%) | (%) |
| 22-1 | 33.8 | 45.0 | 11.2 | 10.0 | 2.80 | 95.20 ± 0.58 | 99.45 ± 0.13 |

As shown in Table 23, the electrolyte of example 22-1 exhibits an ionic conductivity of 2.80 mS/cm. Lithium metal battery comprising the electrolyte exhibits an average Coulombic efficiency (CE) of 99.45%.

### Example 23

In this example, electrolytes were prepared and tested similar to Example 1 except that the compositions are shown in Table 24. The ionic liquid comprises PYR13FSI and 1-ethyl-3-methylimidazolium bis(fluorosulfonyl)imide (EmimFSI).

TABLE 24
Electrolyte compositions according to some embodiments of the present disclosure

| Ex. | LiFSI | PYR13FSI | EmimFSI | DEE | IC | Initial CE | Average CE |
|---|---|---|---|---|---|---|---|
| No. | (wt %) | (wt %) | (wt %) | (wt %) | (mS/cm) | (%) | (%) |
| 23-1 | 37.4 | 25.0 | 25.0 | 12.6 | 5.56 | 95.98 ± 0.35 | 99.37 ± 0.06 |
| 23-2 | 37.4 | 25.4 | 26.9 | 10.3 | 5.72 | 97.65 ± 1.01 | 99.14 ± 0.01 |

As shown in Table 24, the electrolytes of examples 23-1 and 23-2 exhibit an ionic conductivity of 5.56 mS/cm and 5.72 mS/cm, respectively. Lithium metal battery comprising the electrolytes exhibit an average CE of 99.37% and 99.14%, respectively.

### Example 24

TABLE 25
Electrolyte compositions according to some embodiments of the present disclosure

| Ex. | LiFSI | PYR13FSI | EmimFSI | DEE | BTFM | IC | Initial CE | Average CE |
|---|---|---|---|---|---|---|---|---|
| No. | (wt %) | (wt %) | (wt %) | (wt %) | (wt %) | (mS/cm) | (%) | (%) |
| 24-1 | 30.0 | 20.3 | 21.5 | 8.2 | 20.0 | 6.96 | 95.80 ± 0.86 | 99.35 ± 0.06 |
| 24-2 | 25.0 | 15.0 | 15.0 | 15.0 | 30.0 | 8.95 | 96.36 ± 0.04 | 98.94 ± 0.07 |

In this example, electrolytes were prepared and tested similar to Example 1 except that the compositions are shown in Table 25. The cyclic quaternary ammonium ionic liquid is PYR13FSI. An imidazole based ionic liquid, EmimFSI, was used as a second ionic liquid. The solvent comprises a non-fluorinated ether, DEE, and a fluorinated ether, BTFM.

As shown in Table 25, the electrolytes of examples 24-1 and 24-2 exhibit an ionic conductivity of 6.96 mS/cm and 8.95 mS/cm, respectively. Lithium metal batteries comprising the electrolytes exhibit an average CE of 99.35% and 98.94%, respectively.

### Example 25

In this example, electrolyte was prepared and tested similar to Example 1 except that the composition is shown in Table 26. The ionic liquid comprises PYR13FSI and 1-butyl-1-methylpyrrolidinium bis(fluorosulfonyl)imide (PYR14FSI). The lithium salt and both ionic liquids have the same anion, i.e., FSI.

TABLE 26
Electrolyte compositions according to some embodiments of the present disclosure

| Ex. | LiFSI | PYR13FSI | PYR14FSI | DEE | IC | Initial CE | Average CE |
|---|---|---|---|---|---|---|---|
| No. | (wt %) | (wt %) | (wt %) | (wt %) | (mS/cm) | (%) | (%) |
| 25-1 | 37.4 | 25.8 | 26.9 | 9.9 | 2.28 | 95.26 ± 0.68 | 99.46 ± 0.01 |

As shown in Table 26, the electrolyte of example 25-1 exhibits an ionic conductivity of 2.28 mS/cm. Lithium metal battery comprising the electrolytes exhibit an average Coulombic efficiency (CE) of 99.46%.

### Example 26

In this example, electrolytes were prepared and tested similar to Example 1 except that the compositions are shown in Table 27. The ionic liquid comprises PYR13FSI and PYR14FSI, and the solvent comprises a non-fluorinated ether, DEE, and a fluorinated ether, BTFM.

TABLE 27
Electrolyte compositions according to some embodiments of the present disclosure

| Ex. | LiFSI | PYR13FSI | PYR14FSI | DEE | BTFM | IC | Initial CE | Average CE |
|---|---|---|---|---|---|---|---|---|
| No. | (wt %) | (wt %) | (wt %) | (wt %) | (wt %) | (mS/cm) | (%) | (%) |
| 26-1 | 25.0 | 15.0 | 15.0 | 15.0 | 30.0 | 7.46 | 95.96 ± 0.39 | 99.25 ± 0.10 |
| 26-2 | 20.0 | 20.0 | 20.0 | 20.0 | 20.0 | 10.59 | 95.02 ± 0.56 | 99.14 ± 0.02 |
| 26-3 | 30.0 | 20.6 | 21.5 | 7.9 | 20.0 | 4.46 | 95.37 ± 0.64 | 99.39 ± 0.06 |

As shown in Table 27, the electrolytes of examples 26-1, 26-2, and 26-3 exhibit an IC of 7.46 mS/cm, 10.59 mS/cm, and 4.46 mS/cm, respectively. Lithium metal batteries comprising the electrolytes exhibit an average CE of 99.25%, 99.14%, and 99.39%, respectively.

### Example 27

In this example, electrolytes were prepared and tested similar to Example 1 except that the compositions are shown in Table 28. The ionic liquid comprises PYR13FSI and PP13FSI, and the solvent comprises a nonfluorinated ether, DEE, and a fluorinated ether, BTFM.

TABLE 28
Electrolyte compositions according to some embodiments of the present disclosure

| Ex. | LiFSI | PYR13FSI | PP13FSI | DEE | BTFM | IC | Initial CE | Average CE |
|---|---|---|---|---|---|---|---|---|
| No. | (wt %) | (wt %) | (wt %) | (wt %) | (wt %) | (mS/cm) | (%) | (%) |
| 27-1 | 25.0 | 15.0 | 15.0 | 15.0 | 30.0 | 6.61 | 96.32 ± 0.64 | 99.26 ± 0.09 |
| 27-2 | 20.0 | 20.0 | 20.0 | 20.0 | 20.0 | 10.59 | 94.90 ± 0.86 | 99.13 ± 0.07 |

As shown in Table 28, the electrolytes of examples 27-1 and 27-2 exhibit an IC of 6.61 mS/cm and 10.59 mS/cm, respectively. Lithium metal batteries comprising the electrolytes exhibit an average CE of 99.26% and 99.13%, respectively.

### Example 28

In this example, electrolytes were prepared and tested similar to Example 1 except that the compositions are shown in Table 29. The ionic liquid comprises PYR13FSI and PP13FSI, and the solvent comprises DEE and OTE.

TABLE 29
Electrolyte compositions according to some embodiments of the present disclosure

| Ex. | LiFSI | PYR13FSI | PP13FSI | DEE | OTE | IC | Initial CE | Average CE |
|---|---|---|---|---|---|---|---|---|
| No. | (wt %) | (wt %) | (wt %) | (wt %) | (wt %) | (mS/cm) | (%) | (%) |
| 28-1 | 25.0 | 15.0 | 15.0 | 15.0 | 30.0 | 3.52 | 94.74 ± 0.33 | 99.33 ± 0.03 |
| 28-2 | 20.0 | 20.0 | 20.0 | 20.0 | 20.0 | 5.81 | 95.34 ± 0.52 | 99.20 ± 0.07 |

As shown in Table 29, the electrolytes of examples 28-1 and 28-2 exhibit an IC of 3.52 mS/cm and 5.81 mS/cm, respectively. Lithium metal batteries comprising the electrolytes exhibit an average CE of 99.33% and 99.20%, respectively.

### Example 29

An electrolyte comprising a polymer was prepared by mixing Example 1-4 as base electrolyte, pentaerythritol tetraacrylate (PETA) as monomer, and AIBN as initiator followed by polymerization at 65° C. The composition of the polymer electrolyte is shown in Table 30.

TABLE 30
Electrolyte compositions

| Ex. No. | Example 1-4 | PETA | AIBN |
|---|---|---|---|
| 29-1 | 98.35 | 1.50 | 0.15 |

A multi-layer pouch cell comprising Li metal as anode, microporous membrane as separator, NMC811 as cathode, and polymer electrolyte Example 29-1 (Ex. No. 29-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity vs cycle life is shown in FIG. 2. The pouch cell was cycled for 150 cycles until discharge capacity drops below 80% of initial discharge capacity.

In some embodiments, the incorporation of polymer into electrolyte decreases or prevents leakage of electrolyte components therein, thus improving the safety profile.

### Example 30

An electrolyte comprising a polymer was prepared by mixing Example 2-4 as base electrolyte, pentaerythritol tetraacrylate (PETA) as monomer, and AIBN as initiator followed by polymerization at 65° C. The composition of the polymer electrolyte is shown in Table 31.

TABLE 31
Electrolyte compositions

| Ex. No. | Example 2-4 | PETA | AIBN |
|---|---|---|---|
| 30-1 | 98.35 | 1.50 | 0.15 |

A multi-layer pouch cell comprising Li metal as anode, microporous membrane as separator, NMC811 as cathode, and polymer electrolyte Example 30-1 (Ex. No. 30-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity vs cycle life is shown in FIG. 4. The pouch cell was cycled for 223 cycles until discharge capacity drops below 80% of initial discharge capacity.

### Example 31

An electrolyte comprising a polymer was prepared by mixing Example 3-4 as base electrolyte, pentaerythritol tetraacrylate (PETA) as monomer, and AIBN as initiator followed by polymerization at 65° C. The composition of the polymer electrolyte is shown in Table 32.

TABLE 32
Electrolyte compositions

| Ex. No. | Example 3-4 | PETA | AIBN |
|---|---|---|---|
| 31-1 | 98.35 | 1.50 | 0.15 |

A multi-layer pouch cell comprising Li metal as anode, microporous membrane as separator, NMC811 as cathode, and polymer electrolyte Example 31-1 (Ex. No. 31-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity vs cycle life is shown in FIG. 6. The pouch cell was cycled for 220 cycles until discharge capacity drops below 80% of initial discharge capacity.

### Example 32

An electrolyte comprising a polymer was prepared by mixing Example 4-1 as base electrolyte, pentaerythritol tetraacrylate (PETA) as monomer, and AIBN as initiator followed by polymerization at 65° C. The composition of the polymer electrolyte is shown in Table 33.

TABLE 33
Electrolyte compositions

| Ex. No. | Example 4-1 | PETA | AIBN |
|---|---|---|---|
| 32-1 | 98.35 | 1.50 | 0.15 |

A multi-layer pouch cell comprising Li metal as anode, microporous membrane as separator, NMC811 as cathode, and polymer electrolyte Example 32-1 (Ex. No. 32-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity vs cycle life is shown in FIG. 8. The pouch cell was cycled for 180 cycles until discharge capacity drops below 80% of initial discharge capacity.

### Example 33

An electrolyte comprising a polymer was prepared by mixing Example 9-1 as base electrolyte, pentaerythritol tetraacrylate (PETA) as monomer, and AIBN as initiator followed by polymerization at 65° C. The composition of the polymer electrolyte is shown in Table 34.

TABLE 34
Electrolyte compositions

| Ex. No. | Example 9-1 | PETA | AIBN |
|---|---|---|---|
| 33-1 | 98.35 | 1.50 | 0.15 |

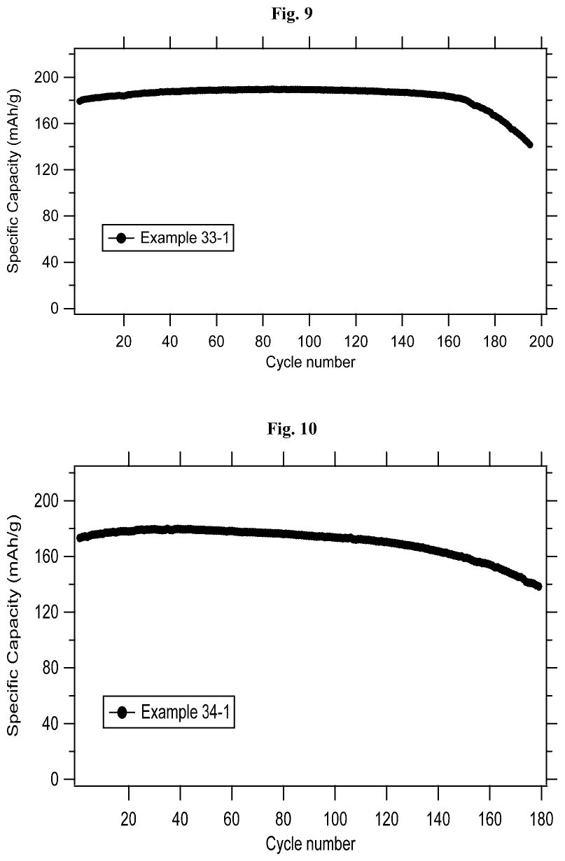

A multi-layer pouch cell comprising Li metal as anode, microporous membrane as separator, NMC811 as cathode, and polymer electrolyte Example 33-1 (Ex. No. 33-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity vs cycle life is shown in FIG. 9. The pouch cell was cycled for 195 cycles until discharge capacity drops below 80% of initial discharge capacity.

### Example 34

An electrolyte comprising a polymer was prepared by mixing Example 12-1 as base electrolyte, pentaerythritol tetraacrylate (PETA) as monomer, and AIBN as initiator followed by polymerization at 65° C. The composition of the polymer electrolyte is shown in Table 35.

TABLE 35
Electrolyte compositions

| Ex. No. | Example 12-1 | PETA | AIBN |
|---|---|---|---|
| 34-1 | 98.35 | 1.50 | 0.15 |

A multi-layer pouch cell comprising Li metal as anode, microporous membrane as separator, NMC811 as cathode, and polymer electrolyte Example 34-1 (Ex. No. 34-1) as electrolyte was cycled between 2.8V to 4.25 V at 25° C. using a current density of 1.0 mA/cm² (0.33 C) under an external pressure in a range from 0.5 MPa to 5.0 MPa. The specific discharge capacity vs cycle life is shown in FIG. 10. The pouch cell was cycled for 178 cycles until discharge capacity drops below 80% of initial discharge capacity.

### Aspects

In a first aspect, the present disclosure provides an electrolyte comprising a lithium salt, a cyclic quaternary ammonium ionic liquid, and an organic solvent with a boiling point of 100° C. or higher.

In a second aspect according to the first aspect, the cyclic quaternary ammonium ionic liquid has a formula of

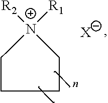

where n is an integer having a value in a range from 1 to 6 and R₁ and R₂ are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl and mixtures thereof and X⁻ is an anion.

In a third aspect according to the second aspect, the cyclic quaternary ammonium ionic liquid comprises at least one compound with a formula selected from the group consisting of:

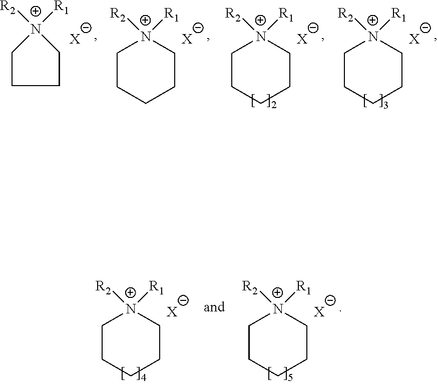

In a fourth aspect according to the second or third aspect, the anion X⁻ is selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br), and mixtures thereof.

In a fifth aspect according to any preceding aspect, the organic solvent is free of ionic structure.

In a sixth aspect according to any preceding aspect, the organic solvent comprises a non-fluorinated ether, a fluorinated ether, or a mixture thereof; wherein the non-fluorinated ether has a formula of

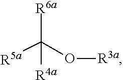

wherein R^{7a} is C₁-C₁₀ alkyl or —[(C₁-C₄ alkylene)-O—]ₓ—(C₁-C₁₀ alkyl), R^{4a}, R^{5a} and R^{6a} are independently H, C₁-C₁₀ alkyl, —[(C₁-C₄ alkylene)-O—]_{y}—(C₁-C₁₀ alkyl), or —O—[(C₁-C₄ alkylene)-O—]_{y}—(C₁-C₁₀ alkyl), and x and y are independently an integer in a range from 1 to 10, and wherein the fluorinated ether has a formula of

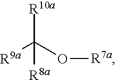

wherein R^{7a} is C₁-C₁₀ alkyl, C₁-C₁₀ fluoroalkyl, —[(C₁-C₄ alkylene)-O—]ₓ—(C₁-C₁₀ alkyl), or —[(C₁-C₄ alkylene)-O—]ₓ—(C₁-C₁₀ fluoroalkyl), R^{8a}, R^{9a} and R^{10a} are independently H, F, C₁-C₁₀ alkyl, C₁-C₁₀ fluoroalkyl, —O—(C₁-C₁₀ alkyl), —O—(C₁-C₁₀ fluoroalkyl), —[(C₁-C₄ alkylene)-O—]_{y}—(C₁-C₁₀ alkyl), —[(C₁-C₄ alkylene)-O—]_{y}—(C₁-C₁₀ fluoroalkyl), —O—[(C₁-C₄ alkylene)-O—]_{y}—(C₁-C₁₀ alkyl), or —O—[(C₁-C₄ alkylene)-O—]_{y}—(C₁-C₁₀ fluoroalkyl), and x and y are independently an integer in a range from 1 to 10, wherein at least one of R^{7a}, R^{8a}, R^{9a} and R^{10a} contains one or more fluorine.

In a seventh aspect according to any preceding aspect, the organic solvent is selected from the group consisting of 1,2-diethoxyethane (DEE), 1,2-dipropoxyethane (DPE), dibutyl ether (DBE), diethylene glycol dimethyl ether (DGL), tris(2,2,2-trifluoroethyl), triethylene glycol dimethyl ether (triglyme), tetraethylene glycol dimethyl ether (tetraglyme), bis(2,2,2-trifluoroethoxy) methane (BTFM), N,N-dimethyltrifluoromethanesulfonamide (DTSA), N,N-diethyltrifluoromethanesulfonamide (ETSA), 1,2-(1,1,2,2-tetrafluoroethoxy) ethane (TFEE), 1,2-bis(2,2-difluoroethoxy) ethane (BDFE), 2-[2-(2,2-difluoroethoxy) ethoxy]-1,1,1-trifluoroethane (DTFE), tris(2,2,2-trifluoroethyl) orthoformate (TFEO), 1H,1H,5H-octafluoropentyl 1,1,2,2-tetrafluoroethyl ether (OTE), tris(2,2,2-trifluoroethyl) phosphite (TFEPi), tris(2,2,2-trifluoroethyl) phosphate (TFEP), diethyl succinate (DESU), diethyl glutarate (DEGL), diethyl adipate (DEAD), diethyl sebacate (DES), trimethyl phosphate (TMP), triethyl phosphate (TEP), and mixtures thereof.

In an eighth aspect according to any preceding aspect, the organic solvent has a weight percentage in a range from 20 wt % to 50 wt % in the electrolyte.

In a nineth aspect according to any preceding aspect, the lithium salt is selected from the group consisting of lithium bis(fluorosulfonyl)imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato) borate (LiBOB), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bis(perfluoroethanesulfonyl)imide (LiBETI), lithium difluoro(oxalato)borate (LiDFOB), lithium fluorophosphate (Li₂PO₃F), lithium difluoro (bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, lithium acetate, lithium trifluoromethyl acetate, lithium oxalate, and a mixture thereof

In a tenth aspect according to any preceding aspect, the cyclic quaternary ammonium ionic liquid is selected from the group consisting of N-propyl-N-methylpyrrolidinium bis(fluorosulfonyl)imide (PYR13FSI), N-propyl-N-methylpyrrolidinium bis(trifluoromethanesulfonyl)imide (PYR13TFSI) 1-butyl-1-methylpyrrolidinium bis(fluorosulfonyl)imide (PYR14FSI), 1-butyl-1-methylpyrrolidinium bis(oxalate)borate (PYR14BOB), 1-butyl-1-methylpyrrolidinium bis(trifluoromethanesulfonyl)imide (PYR14TFSI), 1-butyl-1-methylpyrrolidinium dicyanamide (PYR14DCA), 1-butyl-1-methylpyrrolidinium trifluoromethanesulfonate (PYR14TfO), 1-methyl-1-(2-methoxyethyl) pyrrolidinium bis(fluorosulfonyl)imide (PYOFSI), 1-methyl-1-pentylpyrrolidinium bis(trifluoromethanesulfonyl)imide (PYR15TFSI), 1-methyl-1-octylpyrrolidinium bis(trifluoromethanesulfonyl)imide (PYR18TFSI), N-propyl-N-methylpiperidinium bis(fluorosulfonyl)imide, N-propyl-N-methylpiperidinium bis(trifluoromethanesulfonyl)imide, 1-butyl-1-methylpiperidinium bis(fluorosulfonyl)imide, 1-butyl-1-methylpiperidinium bis(oxalate)borate, 1-butyl-1-methylpiperidinium bis(trifluoromethanesulfonyl)imide, 1-butyl-1-methylpiperidinium dicyanamide, 1-butyl-1-methylpiperidinium trifluoromethanesulfonate, 1-methyl-1-(2-methoxyethyl) piperidinium bis(fluorosulfonyl)imide, 1-methyl-1-pentylpiperidinium bis(trifluoromethanesulfonyl)imide, 1-methyl-1-octylpiperidinium bis(trifluoromethanesulfonyl)imide, N-propyl-N-methylazepanium bis(fluorosulfonyl)imide, N-propyl-N-methylazepanium bis(trifluoromethanesulfonyl)imide, 1-butyl-1-methylazepanium bis(fluorosulfonyl)imide, 1-butyl-1-methylazepanium bis(oxalate)borate, 1-butyl-1-methylazepanium bis(trifluoromethanesulfonyl)imide, 1-butyl-1-methyl azepanium dicyanamide, 1-butyl-1-methylazepanium trifluoromethanesulfonate, 1-methyl-1-(2-methoxyethyl) azepanium bis(fluorosulfonyl)imide, 1-methyl-1-pentylazepanium bis(trifluoromethanesulfonyl)imide, 1-methyl-1-octylazepanium bis(trifluoromethanesulfonyl)imide, and mixtures thereof.

In an eleventh aspect according to any of the first through tenth aspects, the electrolyte comprises: 20 wt % to 40 wt % of the lithium salt, 20 wt % to 40 wt % of the cyclic quaternary ammonium ionic liquid, 20 wt % to 40 wt % of a nonfluorinated ether as the organic solvent.

In a twelfth aspect according to any of the first through tenth aspects, the electrolyte comprises: 20 wt % to 40 wt % of the lithium salt, 20 wt % to 40 wt % of the cyclic quaternary ammonium ionic liquid, 20 wt % to 40 wt % of a fluorinated ether as the organic solvent.

In a thirteenth aspect according to any of the first through tenth aspects, the electrolyte comprises: 15 wt % to 35 wt % of the lithium salt, 20 wt % to 40 wt % of the cyclic quaternary ammonium ionic liquid, 15 wt % to 35 wt % of a nonfluorinated ether and 15 wt % to 35 wt % of a fluorinated ether, wherein the nonfluorinated ether and the fluorinated ether are the organic solvent, wherein the organic solvent is at least 35 wt % in the electrolyte.

In a fourteenth aspect according to any preceding aspects, the electrolyte further comprises a second ionic liquid different from the cyclic quaternary ammonium ionic liquid.

In a fifteenth aspect according to the fourteenth aspect, the second ionic liquid is an imidazolium-based ionic liquid. In some embodiments, the second ionic liquid comprises at least one selected from the group consisting of 1-ethyl-3-methylimidazolium bis(fluorosulfonyl)imide (EmimFSI), 1-butyl-3-methylimidazolium bis(fluorosulfonyl)imide (BmimFSI), 1-hexyl-3-methylimidazolium bis(fluorosulfonyl)imide (HmimFSI), 1-vinyl-3-methylimidazolium bis(fluorosulfonyl)imide (VmimFSI), 1-ethyl-3-methylimidazolium bis(trifluoromethanesulfonyl)imide (EmimTFSI), 1-butyl-3-methylimidazolium bis(trifluoromethanesulfonyl)imide (Bmim TFSI), 1-hexyl-3-methylimidazolium bis(trifluoromethanesulfonyl)imide (Hmim TFSI), 1-vinyl-3-methylimidazolium bis(trifluoromethanesulfonyl)imide (VmimTFSI), and mixtures thereof.

In a sixteenth aspect according to any preceding aspects, the electrolyte further comprises a polymer with a concentration in a range from 0.02 wt % to 40 wt % in the electrolyte.

In a seventeenth aspect according to the sixteenth aspect, the polymer is in situ polymerized after mixing a monomer with the lithium salt, the cyclic quaternary ammonium ionic liquid and the organic solvent.

In an eighteenth aspect according to the seventeenth aspect, the monomer is selected from the group consisting of 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn ranging from 500 to 5000), triethylene glycol dimethacrylate (TEGDMA), diurethane dimethacrylate, tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl] isocyanurate (TAEI), di(trimethylolpropane) tetraacrylate (Di-TMPTA), trimethylolpropane propoxylate triacrylate, trimethylolpropane trimethacrylate, pentaerythritol triacrylate, dipentaerythritol hexaacrylate, and mixtures thereof.

In a nineteenth aspect according to any preceding aspect, the electrolyte does not include any solvent that has a boiling point less than 100° C.

In a twentieth aspect, the present disclosure provides an electrochemical device comprising the electrolyte according to any preceding aspect.

In a twenty-first aspect according to the twentieth aspect, the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below. In some embodiments, after the hotbox test, the electrochemical device does not experience leakage of the electrolyte, does not explode, and/or does not experience a weight loss of greater than 50% of the total weight of electrolyte.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternative to the specific embodiments described herein are also within the scope of this disclosure.

1. An electrolyte comprising:
a) a lithium salt,
b) a cyclic quaternary ammonium ionic liquid, and
c) an organic solvent with a boiling point of 100° C. or higher measured at 760 mm Hg, wherein the organic solvent is free of ionic structure.

2. The electrolyte of claim 1, wherein the cyclic quaternary ammonium ionic liquid has a formula of 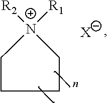
where n is an integer having a value in a range from 1 to 6 and R₁ and R₂ are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, C₆₋₁₈ aryl and mixtures thereof and X⁻ is an anion.

3. The electrolyte of claim 1, wherein the cyclic quaternary ammonium ionic liquid has a formula selected from the group consisting of:

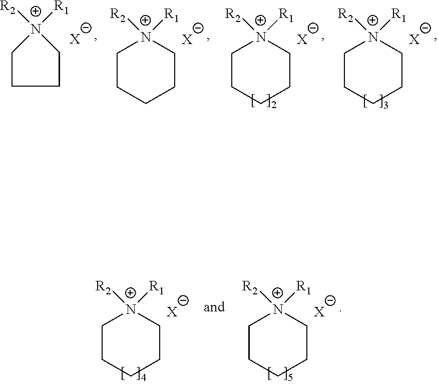

4. The electrolyte of claim 2, wherein the anion X⁻ is selected from the group consisting of bis(fluorosulfonyl)imide (FSI⁻), bis(trifluoromethanesulfonyl)imide (TFSI), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and mixtures thereof.

5. The electrolyte of claim 1, wherein the organic solvent comprises a non-fluorinated ether, a fluorinated ether, or a mixture thereof; wherein the non-fluorinated ether has a formula of 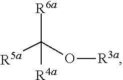
wherein R^{3a} is C₁-C₁₀ alkyl or —[(C₁-C₄ alkylene)-O—]ₓ—(C₁-C₁₀ alkyl), R^{4a}, R^{5a} and R^{6a} are independently H, C₁-C₁₀ alkyl, —[(C₁-C₄ alkylene)-O—]_{y}—(C₁-C₁₀ alkyl), or —O—[(C₁-C₄ alkylene)-O—]_{y}—(C₁-C₁₀ alkyl), and x and y are independently an integer in a range from 1 to 10, and wherein the fluorinated ether has a formula of 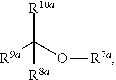
wherein R^{7a} is C₁-C₁₀ alkyl, C₁-C₁₀ fluoroalkyl, —[(C₁-C₄ alkylene)-O—]ₓ—(C₁-C₁₀ alkyl), or —[(C₁-C₄ alkylene)-O—]ₓ—(C₁-C₁₀ fluoroalkyl), R^{8a}, R^{9a} and R^{10a} are independently H, F, C₁-C₁₀ alkyl, C₁-C₁₀ fluoroalkyl, —O—(C₁-C₁₀ alkyl), —O—(C₁-C₁₀ fluoroalkyl), —[(C₁-C₄ alkylene)-O—]_{y}—(C₁-C₁₀ alkyl), —[(C₁-C₄ alkylene)-O—]_{y}—(C₁-C₁₀ fluoroalkyl), —O—[(C₁-C₄ alkylene)-O—]_{y}—(C₁-C₁₀ alkyl), or —O—[(C₁-C₄ alkylene)-O—]_{y}—(C₁-C₁₀ fluoroalkyl), and x and y are independently an integer in a range from 1 to 10, wherein at least one of R^{7a}, R^{8a}, R^{9a} and R^{10a} contains one or more fluorine.

6. The electrolyte of claim 1, wherein the organic solvent is selected from the group consisting of 1,2-diethoxyethane (DEE), 1,2-dipropoxyethane (DPE), dibutyl ether (DBE), diethylene glycol dimethyl ether (DGL), triethylene glycol dimethyl ether (triglyme), tetraethylene glycol dimethyl ether (tetraglyme), bis(2,2,2-trifluoroethoxy) methane (BTFM), N,N-dimethyltrifluoromethanesulfonamide (DTSA), N,N-diethyltrifluoromethanesulfonamide (ETSA), 1,2-(1,1,2,2-tetrafluoroethoxy) ethane (TFEE), 1,2-bis(2,2-difluoroethoxy) ethane (BDFE), 2-[2-(2,2-difluoroethoxy) ethoxy]-1,1,1-trifluoroethane (DTFE), tris(2,2,2-trifluoroethyl) orthoformate (TFEO), 1H,1H,5H-octafluoropentyl 1,1,2,2-tetrafluoroethyl ether (OTE), tris(2,2,2-trifluoroethyl) phosphite (TFEPi), tris(2,2,2-trifluoroethyl) phosphate (TFEP), diethyl succinate (DESU), diethyl glutarate (DEGL), diethyl adipate (DEAD), diethyl sebacate (DES), trimethyl phosphate (TMP), triethyl phosphate (TEP), and mixtures thereof.

7. The electrolyte of claim 1, wherein the organic solvent has a weight percentage in a range from 20 wt % to 50 wt % in the electrolyte.

8. The electrolyte of claim 1, wherein the lithium salt is selected from the group consisting of lithium bis(fluorosulfonyl)imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato) borate (LiBOB), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bis(perfluoroethanesulfonyl)imide (LiBETI), lithium difluoro(oxalato)borate (LiDFOB), lithium fluorophosphate (Li₂PO₃F), lithium difluoro (bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, LiF, LiCl, LiBr, LiI, Li₂SO₄, Li₃PO₄, Li₂CO₃, lithium acetate, lithium trifluoromethyl acetate, lithium oxalate, and a mixture thereof.

9. The electrolyte of claim 1, wherein the cyclic quaternary ammonium ionic liquid is selected from the group consisting of N-propyl-N-methylpyrrolidinium bis(fluorosulfonyl)imide (PYR13FSI), N-propyl-N-methylpyrrolidinium bis(trifluoromethanesulfonyl)imide (PYR13TFSI) 1-butyl-1-methylpyrrolidinium bis(fluorosulfonyl)imide (PYR14FSI), 1-butyl-1-methylpyrrolidinium bis(oxalate)borate (PYR14BOB), 1-butyl-1-methylpyrrolidinium bis(trifluoromethanesulfonyl)imide (PYR14TFSI), 1-butyl-1-methylpyrrolidinium dicyanamide (PYR14DCA), 1-butyl-1-methylpyrrolidinium trifluoromethanesulfonate (PYR14TfO), 1-methyl-1-(2-methoxyethyl) pyrrolidinium bis(fluorosulfonyl)imide (PYOFSI), 1-methyl-1-pentylpyrrolidinium bis(trifluoromethanesulfonyl)imide (PYR15TFSI), 1-methyl-1-octylpyrrolidinium bis(trifluoromethanesulfonyl)imide (PYR18TFSI), N-propyl-N-methylpiperidinium bis(fluorosulfonyl)imide, N-propyl-N-methylpiperidinium bis(trifluoromethanesulfonyl)imide, 1-butyl-1-methylpiperidinium bis(fluorosulfonyl)imide, 1-butyl-1-methylpiperidinium bis(oxalate)borate, 1-butyl-1-methylpiperidinium bis(trifluoromethanesulfonyl)imide, 1-butyl-1-methylpiperidinium dicyanamide, 1-butyl-1-methylpiperidinium trifluoromethanesulfonate, 1-methyl-1-(2-methoxyethyl) piperidinium bis(fluorosulfonyl)imide, 1-methyl-1-pentylpiperidinium bis(trifluoromethanesulfonyl)imide, 1-methyl-1-octylpiperidinium bis(trifluoromethanesulfonyl)imide, N-propyl-N-methylazepanium bis(fluorosulfonyl)imide, N-propyl-N-methylazepanium bis(trifluoromethanesulfonyl)imide, 1-butyl-1-methylazepanium bis(fluorosulfonyl)imide, 1-butyl-1-methylazepanium bis(oxalate)borate, 1-butyl-1-methylazepanium bis(trifluoromethanesulfonyl)imide, 1-butyl-1-methyl azepanium dicyanamide, 1-butyl-1-methylazepanium trifluoromethanesulfonate, 1-methyl-1-(2-methoxyethyl) azepanium bis(fluorosulfonyl)imide, 1-methyl-1-pentylazepanium bis(trifluoromethanesulfonyl)imide, 1-methyl-1-octylazepanium bis(trifluoromethanesulfonyl)imide, and mixtures thereof.

10. The electrolyte of claim 1, wherein the electrolyte comprises: 20 wt % to 40 wt % of the lithium salt, 20 wt % to 40 wt % of the cyclic quaternary ammonium ionic liquid, 20 wt % to 40 wt % of a nonfluorinated ether as the organic solvent.

11. The electrolyte of claim 1, wherein the electrolyte comprises: 20 wt % to 40 wt % of the lithium salt, 20 wt % to 40 wt % of the cyclic quaternary ammonium ionic liquid, 20 wt % to 40 wt % of a fluorinated ether as the organic solvent.

12. The electrolyte of claim 1, wherein the electrolyte comprises: 15 wt % to 35 wt % of the lithium salt, 20 wt % to 40 wt % of the cyclic quaternary ammonium ionic liquid, 15 wt % to 35 wt % of a nonfluorinated ether and 15 wt % to 35 wt % of a fluorinated ether, wherein the nonfluorinated ether and the fluorinated ether are the organic solvent, wherein the organic solvent is at least 35 wt % in the electrolyte.

13. The electrolyte of claim 1, further comprising a second ionic liquid different from the cyclic quaternary ammonium ionic liquid.

14. The electrolyte of claim 13, wherein the second ionic liquid is an imidazolium-based ionic liquid.

15. The electrolyte of claim 1, further comprising a polymer with a concentration in a range from 0.02 wt % to 40 wt % in the electrolyte.

16. The electrolyte of claim 15, wherein the polymer is in situ polymerized after mixing a monomer with the lithium salt, the cyclic quaternary ammonium ionic liquid and the organic solvent.

17. The electrolyte of claim 16, wherein the monomer is selected from the group consisting of 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn ranging from 500 to 5000), triethylene glycol dimethacrylate (TEGDMA), diurethane dimethacrylate, tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl] isocyanurate (TAEI), di(trimethylolpropane) tetraacrylate (Di-TMPTA), trimethylolpropane propoxylate triacrylate, trimethylolpropane trimethacrylate, pentaerythritol triacrylate, dipentaerythritol hexaacrylate, and mixtures thereof.

18. The electrolyte of claim 1, wherein the electrolyte does not include any solvent that has a boiling point less than 100° C. measured at 760 mm Hg.

19. An electrochemical device comprising the electrolyte of claim 1.

20. The electrochemical device of claim 19, wherein the electrochemical device passes a hotbox test, wherein the electrochemical device is at 100% state-of-charge and is held at each of the following temperatures: 130° C., 140° C., 150° C., 160° C., 170° C., 180° C., and 190° C. for 10 minutes with a European Council for Automotive Research (EUCAR) hazard level of 4 or below.
